(19) United States
(12) Patent Application Publication
(10) Pub. No.: US 2023/0143652 A1
(43) Pub. Date: May 11, 2023

(54) Automated Synthesizing of Quantum Programs

(71) Applicant: Rigetti & Co, LLC, Berkeley, CA (US)

(72) Inventors: Keri Ann McKiernan, San Francisco, CA (US); Robert Stanley Smith, Emeryville, CA (US); Chad Tyler Rigetti, Walnut Creek, CA (US); Erik Joseph Davis, Berkeley, CA (US); Muhammad Sohaib Alam, Emeryville, CA (US)

(73) Assignee: Rigetti & Co, LLC, Berkeley, CA (US)

(21) Appl. No.: 17/399,560

(22) Filed: Aug. 11, 2021

Related U.S. Application Data
(63) Continuation of application No. PCT/US2020/018228, filed on Feb. 14, 2020.
(60) Provisional application No. 62/806,015, filed on Feb. 15, 2019.
(60) Provisional application No. 62/884,272, filed on Aug. 8, 2019.
(60) Provisional application No. 62/947,365, filed on Dec. 12, 2019.

(51) Int. Cl. G06N 10/20; G06N 3/10

(52) U.S. Cl. CPC G06N 10/20; G06N 3/10

(57) ABSTRACT

In a general aspect, a quantum program is automatically synthesized. In some implementations, artificial intelligence systems are used to generate a quantum program to run on a quantum computer. In some aspects, quantum processor output data are generated by a quantum resource executing an initial version of a quantum program, and quantum state information is computed from the quantum processor output data. Neural network input data, which include the quantum state information and a representation of a problem to be solved by the quantum program, are provided to a neural network. Neural network output data are generated by the neural network processing the neural network input data. A quantum logic gate is selected based on the neural network output data. An updated version of the quantum program that includes the selected quantum logic gate is generated.

### CROSS REFERENCE TO RELATED APPLICATIONS

This application claims priority to U.S. Provisional Patent Application No. 62/806,015, filed Feb. 15, 2019, entitled “Automated Synthesizing of Quantum Programs;” U.S. Provisional Patent Application No. 62/884,272, filed Aug. 8, 2019, entitled “Automated Synthesizing of Quantum Programs;” and U.S. Provisional Patent Application No. 62/947,365, filed Dec. 12, 2019, entitled “Automated Synthesizing of Quantum Programs.” All of the above-referenced priority documents are incorporated herein by reference.

### BACKGROUND

The following description relates to automated synthesizing of quantum programs.

Quantum computers can perform computational tasks by executing quantum algorithms. A quantum algorithm can be represented, for example, as a quantum Hamiltonian, a sequence of quantum logic operations, a set of quantum machine instructions, or otherwise. A variety of physical systems have been proposed as quantum computing systems. Examples include superconducting circuits, trapped ions, spin systems and others.

### DESCRIPTION OF DRAWINGS

FIG. 1 is a block diagram of an example computing system.

FIG. 2 is a schematic diagram of example modules in a computing system.

FIG. 3 is a flow diagram of an example training process for synthesizing quantum logic circuits.

FIG. 4 is a flow diagram of an example sampling process for synthesizing quantum logic circuits.

FIG. 5 is a flow diagram of another example training process for synthesizing quantum logic circuits.

FIG. 6 is a flow diagram of another example sampling process for synthesizing quantum logic circuits.

FIG. 7 is a flow diagram of another example training process for synthesizing quantum logic circuits.

FIG. 8 is a diagram of hardware elements in an example computing system.

FIG. 9 is a flow diagram of an example process for synthesizing quantum logic circuits.

FIG. 10 is a flow diagram of another example process for synthesizing quantum logic circuits.

FIG. 11 is a schematic diagram showing an example function that measures an immediate value of an action.

### DETAILED DESCRIPTION

In some aspects of what is described here, classical artificial intelligence (AI) systems are used to generate quantum programs that can be executed on quantum computers. For example, a problem or a class of problems to be solved by a quantum program (e.g., an optimization problem or another type of problem) can be formulated and provided as an input to the AI-based quantum program synthesis process. In some cases, a statistical model is developed through a training process, and the statistical model can be used to synthesize quantum programs for specific problems (e.g., specific problems in a class of problems that the statistical model has trained on).

Classical artificial intelligence systems generally use computational models developed through training to make decisions. Some example classical artificial intelligence systems use neural networks, support vector machines, classifiers, decision trees, or other types of statistical models to make decisions, and learning algorithms may be used to train the statistical models. For instance, statistical models can be trained by transfer learning algorithms, reinforcement learning algorithms, deep learning algorithms, asynchronous reinforcement learning algorithms, deep reinforcement learning algorithms or other types of learning algorithm. These and other types of classical artificial intelligence systems and associated learning algorithms may be used to generate an algorithm to run on a quantum computer.

In some implementations, neural networks are used to generate quantum programs. For instance, a training process can be used to train the neural network (e.g., using deep reinforcement learning or another type of machine learning process), and then the neural network can be sampled to construct quantum programs configured to generate solutions to specific problems.

In some instances, a quantum program is synthesized by iteratively adding quantum logic gates to a quantum logic circuit, and a statistical model is used to select the quantum logic gate to be added to the quantum logic circuit on each iteration. For instance, a neural network may provide a distribution of values for a set of allowed quantum logic gates, such that the distribution indicates each gate's relative likelihood of improving the quantum program. The neural network may produce the distribution based on data obtained from executing a current version of the quantum program on a quantum resource (e.g., on one or more quantum processor units, one or more quantum virtual machines, etc.). For instance, information characterizing the quantum state produced by the current version of the quantum program, a figure of merit for the current version of the quantum program (e.g., a “reward” or an equivalent cost function defined by an environment), and a problem to be solved by the quantum program may be provided as inputs to the neural network.

In some implementations, the techniques and systems described here provide technical advantages and improvements over existing approaches. For example, the quantum program synthesis techniques described here can provide an automated process for generating quantum programs to find solutions to specific problems (e.g., optimization problems or other types of problems). In some cases, the quantum program synthesis process constructs a quantum logic circuit using a library of quantum logic gates that are available to a specific type or class of quantum processors. The quantum logic gates may include parametric gates that can be further optimized for an individual quantum resource. In some cases, the quantum program synthesis techniques described here can be parallelized across many classical, quantum or hybrid (classical/quantum) resources in a computing system. And in some cases, multiple levels of optimization can be applied to utilize classical and quantum resources efficiently for solving optimization problems. Accordingly, in some cases, the techniques described here can improve the speed, efficiency and accuracy with which quantum resources are used to solve optimization problems.

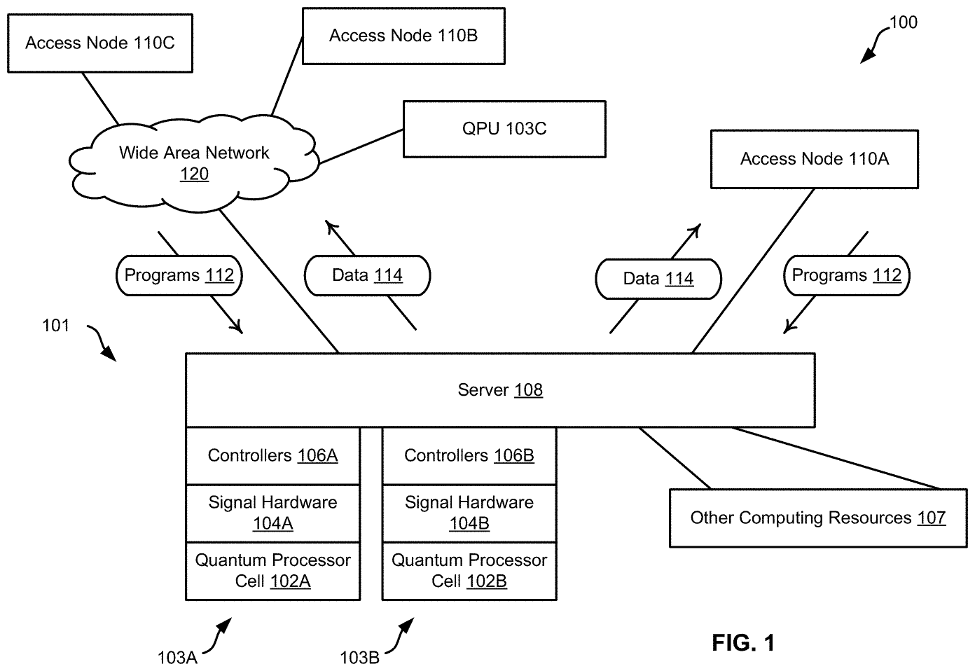

FIG. 1 is a block diagram of an example computing system 100. The example computing system 100 shown in FIG. 1 includes a computing environment 101 and access nodes 110A, 110B, 110C. A computing system may include additional or different features, and the components of a computing system may operate as described with respect to FIG. 1 or in another manner.

The example computing environment 101 includes computing resources and exposes their functionality to the access nodes 110A, 110B, 110C (referred to collectively as “access nodes 110”). The computing environment 101 shown in FIG. 1 includes a server 108, quantum processor units 103A, 103B and other computing resources 107. The computing environment 101 may also include one or more of the access nodes (e.g., the example access node 110A) and other features and components. A computing environment may include additional or different features, and the components of a computing environment may operate as described with respect to FIG. 1 or in another manner.

The example computing environment 101 can provide services to the access nodes 110, for example, as a cloud-based or remote-accessed computer, as a distributed computing resource, as a supercomputer or another type of high-performance computing resource, or in another manner. The computing environment 101 or the access nodes 110 may also have access to one or more remote QPUs (e.g., QPU 103C). As shown in FIG. 1, to access computing resources of the computing environment 101, the access nodes 110 send programs 112 to the server 108 and in response, the access nodes 110 receive data 114 from the server 108. The access nodes 110 may access services of the computing environment 101 in another manner, and the server 108 or other components of the computing environment 101 may expose computing resources in another manner.

Any of the access nodes 110 can operate local to, or remote from, the server 108 or other components of the computing environment 101. In the example shown in FIG. 1, the access node 110A has a local data connection to the server 108 and communicates directly with the server 108 through the local data connection. The local data connection can be implemented, for instance, as a wireless Local Area Network, an Ethernet connection, or another type of wired or wireless connection. Or in some cases, a local access node can be integrated with the server 108 or other components of the computing environment 101. Generally, the computing system 100 can include any number of local access nodes.

In the example shown in FIG. 1, the access nodes 110B, 110C and the QPU 103C each have a remote data connection to the server 108, and each communicates with the server 108 through the remote data connection. The remote data connection in FIG. 1 is provided by a wide area network 120, such as, for example, the Internet or another type of wide area communication network. In some cases, remote access nodes use another type of remote data connection (e.g., satellite-based connections, a cellular network, a private network, etc.) to access the server 108. Generally, the computing system 100 can include any number of remote access nodes.

The example server 108 shown in FIG. 1 communicates with the access nodes 110 and the computing resources in the computing environment 101. For example, the server 108 can delegate computational tasks to the quantum processor units 103A, 103B and the other computing resources 107, and the server 108 can receive the output data from the computational tasks performed by the quantum processor units 103A, 103B and the other computing resources 107. In some implementations, the server 108 includes a personal computing device, a computer cluster, one or more servers, databases, networks, or other types of classical or quantum computing equipment. The server 108 may include additional or different features, and may operate as described with respect to FIG. 1 or in another manner.

Each of the example quantum processor units 103A, 103B operates as a quantum computing resource in the computing environment 101. The other computing resources 107 may include additional quantum computing resources (e.g., quantum processor units, quantum virtual machines (QVMs) or quantum simulators) as well as classical (non-quantum) computing resources such as, for example, digital microprocessors, specialized co-processor units (e.g., graphics processing units (GPUs), cryptographic co-processors, etc.), special purpose logic circuitry (e.g., field programmable gate arrays (FPGAs), application-specific integrated circuits (ASICs), etc.), systems-on-chips (SoCs), etc., or combinations of these and other types of computing modules.

In some implementations, the server 108 generates computing jobs, identifies an appropriate computing resource (e.g., a QPU or QVM) in the computing environment 101 to execute the computing job, and sends the computing job to the identified resource for execution. For example, the server 108 may send a computing job to the quantum processor unit 103A, the quantum processor unit 103B or any of the other computing resources 107. A computing job can be formatted, for example, as a computer program, function, code or other type of computer instruction set. Each computing job includes instructions that, when executed by an appropriate computing resource, perform a computational task and generate output data based on input data. For example, a computing job can include instructions formatted for a quantum processor unit, a quantum virtual machine, a digital microprocessor, co-processor or other classical data processing apparatus, or another type of computing resource.

In some implementations, the server 108 operates as a host system for the computing environment 101. For example, the access nodes 110 may send programs 112 to server 108 for execution in the computing environment 101. The server 108 can store the programs 112 in a program queue, generate one or more computing jobs for executing the programs 112, generate a schedule for the computing jobs, allocate computing resources in the computing environment 101 according to the schedule, and delegate the computing jobs to the allocated computing resources. The server 108 can receive, from each computing resource, output data from the execution of each computing job. Based on the output data, the server 108 may generate additional computing jobs, generate data 114 that is provided back to an access node 110, or perform another type of action.

In some implementations, all or part of the computing environment 101 operates as a cloud-based quantum computing (QC) environment, and the server 108 operates as a host system for the cloud-based QC environment. For example, the programs 112 can be formatted as quantum computing programs for execution by one or more quantum processor units. The server 108 can allocate quantum computing resources (e.g., one or more QPUs, one or more quantum virtual machines, etc.) in the cloud-based QC environment according to the schedule, and delegate quantum computing jobs to the allocated quantum computing resources for execution.

In some implementations, all or part of the computing environment 101 operates as a hybrid computing environment, and the server 108 operates as a host system for the hybrid environment. For example, the programs 112 can be formatted as hybrid computing programs, which include instructions for execution by one or more quantum processor units and instructions that can be executed by another type of computing resource. The server 108 can allocate quantum computing resources (e.g., one or more QPUs, one or more quantum virtual machines, etc.) and other computing resources in the hybrid computing environment according to the schedule, and delegate computing jobs to the allocated computing resources for execution. The other (non-quantum) computing resources in the hybrid environment may include, for example, one or more digital microprocessors, one or more specialized co-processor units (e.g., graphics processing units (GPUs), cryptographic co-processors, etc.), special purpose logic circuitry (e.g., field programmable gate arrays (FPGAs), application-specific integrated circuits (ASICs), etc.), systems-on-chips (SoCs), or other types of computing modules.

In some cases, the server 108 can select the type of computing resource (e.g., quantum or otherwise) to execute an individual computing job in the computing environment 101. For example, the server 108 may select a particular quantum processor unit (QPU) or other computing resource based on availability of the resource, speed of the resource, information or state capacity of the resource, a performance metric (e.g., process fidelity) of the resource, or based on a combination of these and other factors. In some cases, the server 108 can perform load balancing, resource testing and calibration, and other types of operations to improve or optimize computing performance.

The example server 108 shown in FIG. 1 may include a quantum machine instruction library or other resources that the server 108 uses to produce quantum computing jobs to be executed by quantum computing resources in the computing environment 101 (e.g., by the quantum processor unit 103). The quantum machine instruction library may include, for example, calibration procedures, hardware tests, quantum algorithms, quantum gates, etc. The quantum machine instruction library can include a file structure, naming convention, or other system that allows the resources in the quantum machine instruction library to be invoked by the programs 112. For instance, the server 108 or the computing environment 101 can expose the quantum machine instruction library to the access nodes 110 through a set of application programming interfaces (APIs). Accordingly, the programs 112 that are produced by the access nodes 110 and delivered to the server 108 may include information that invokes a quantum machine instruction library stored at the server 108. In some implementations, one or more of the access nodes 110 includes a local version of a quantum machine instruction library. Accordingly, the programs 112 that are produced by the access node 110B and delivered to the server 108 may include instruction sets from a quantum machine instruction library.

Each of the example quantum processor units 103A, 103B shown in FIG. 1 can perform quantum computational tasks by executing quantum machine instructions. In some implementations, a quantum processor unit can perform quantum computation by storing and manipulating information within quantum states of a composite quantum system. For example, qubits (i.e., quantum bits) can be stored in and represented by an effective two-level sub-manifold of a quantum coherent physical system. In some instances, quantum logic can be executed in a manner that allows large-scale entanglement within the quantum system. Control signals can manipulate the quantum states of individual qubits and the joint states of multiple qubits. In some instances, information can be read out from the composite quantum system by measuring the quantum states of the qubits. In some implementations, the quantum states of the qubits are read out by measuring the transmitted or reflected signal from auxiliary quantum devices that are coupled to individual qubits.

In some implementations, a quantum processor unit (e.g., QPU 103A or QPU 103B) can operate using gate-based models for quantum computing. For example, the qubits can be initialized in an initial state, and a quantum logic circuit comprised of a series of quantum logic gates can be applied to transform the qubits and extract measurements representing the output of the quantum computation. In some implementations, a quantum processor unit (e.g., QPU 103A or QPU 103B) can operate using adiabatic or annealing models for quantum computing. For instance, the qubits can be initialized in an initial state, and the controlling Hamiltonian can be transformed adiabatically by adjusting control parameters to another state that can be measured to obtain an output of the quantum computation.

In some models, fault-tolerance can be achieved by applying a set of high-fidelity control and measurement operations to the qubits. For example, quantum error correcting schemes can be deployed to achieve fault-tolerant quantum computation, or other computational regimes may be used. Pairs of qubits can be addressed, for example, with two-qubit logic operations that are capable of generating entanglement, independent of other pairs of qubits. In some implementations, more than two qubits can be addressed, for example, with multi-qubit quantum logic operations capable of generating multi-qubit entanglement. In some implementations, the quantum processor unit 103A is constructed and operated according to a scalable quantum computing architecture. For example, in some cases, the architecture can be scaled to a large number of qubits to achieve large-scale general purpose coherent quantum computing.

The example quantum processor unit 103A shown in FIG. 1 includes controllers 106A, signal hardware 104A, and a quantum processor cell 102A; similarly, the example quantum processor unit 103B shown in FIG. 1 includes controllers 106B, signal hardware 104B, and a quantum processor cell 102B. A quantum processor unit may include additional or different features, and the components of a quantum processor unit may operate as described with respect to FIG. 1 or in another manner.

In some instances, all or part of the quantum processor cell 102A functions as a quantum processor, a quantum memory, or another type of subsystem. In some examples, the quantum processor cell 102A includes a quantum circuit system. The quantum circuit system may include qubit devices, resonator devices and possibly other devices that are used to store and process quantum information. In some cases, the quantum processor cell 102A includes a superconducting circuit, and the qubit devices are implemented as circuit devices that include Josephson junctions, for example, in superconducting quantum interference device (SQUID) loops or other arrangements, and are controlled by radio-frequency signals, microwave signals, and bias signals delivered to the quantum processor cell 102A. In some cases, the quantum processor cell 102A includes an ion trap system, and the qubit devices are implemented as trapped ions controlled by optical signals delivered to the quantum processor cell 102A. In some cases, the quantum processor cell 102A includes a spin system, and the qubit devices are implemented as nuclear or electron spins controlled by microwave or radio-frequency signals delivered to the quantum processor cell 102A. The quantum processor cell 102A may be implemented based on another physical modality of quantum computing.

In some cases, a single quantum processor unit can include multiple quantum processor cells. For example, the QPU 103A can be a dual-QPU that includes multiple independent quantum processor cells in a shared environment. For instance, the dual-QPU may include two independently-operated superconducting quantum processor circuits in the same cryogenic environment, on the same chip or substrate, or in another type of shared circuit environment. In some cases, the QPU 103A includes two, three, four or more quantum processor cells that can operate in parallel based on interactions with with the controllers 106A.

In some implementations, the example quantum processor cell 102A can process quantum information by applying control signals to the qubits in the quantum processor cell 102A. The control signals can be configured to encode information in the qubits, to process the information by performing quantum logic gates or other types of operations, or to extract information from the qubits. In some examples, the operations can be expressed as single-qubit logic gates, two-qubit logic gates, or other types of quantum logic gates that operate on one or more qubits. A sequence of quantum logic operations can be applied to the qubits to perform a quantum algorithm. The quantum algorithm may correspond to a computational task, a hardware test, a quantum error correction procedure, a quantum state distillation procedure, or a combination of these and other types of operations.

The example signal hardware 104A includes components that communicate with the quantum processor cell 102A. The signal hardware 104A may include, for example, waveform generators, amplifiers, digitizers, high-frequency sources, DC sources, AC sources and other type of components. The signal hardware may include additional or different features and components. In the example shown, components of the signal hardware 104A are adapted to interact with the quantum processor cell 102A. For example, the signal hardware 104A can be configured to operate in a particular frequency range, configured to generate and process signals in a particular format, or the hardware may be adapted in another manner.

In some instances, one or more components of the signal hardware 104A generate control signals, for example, based on control information from the controllers 106A. The control signals can be delivered to the quantum processor cell 102A to operate the quantum processor unit 103A. For instance, the signal hardware 104A may generate signals to implement quantum logic operations, readout operations or other types of operations. As an example, the signal hardware 104A may include arbitrary waveform generators (AWGs) that generate electromagnetic waveforms (e.g., microwave or radio-frequency) or laser systems that generate optical waveforms. The waveforms or other types of signals generated by the signal hardware 104A can be delivered to devices in the quantum processor cell 102A to operate qubit devices, readout devices, bias devices, coupler devices or other types of components in the quantum processor cell 102A.

In some instances, the signal hardware 104A receives and processes signals from the quantum processor cell 102A. The received signals can be generated by operation of the quantum processor unit 103A. For instance, the signal hardware 104A may receive signals from the devices in the quantum processor cell 102A in response to readout or other operations performed by the quantum processor cell 102A. Signals received from the quantum processor cell 102A can be mixed, digitized, filtered, or otherwise processed by the signal hardware 104A to extract information, and the information extracted can be provided to the controllers 106A or handled in another manner. In some examples, the signal hardware 104A may include a digitizer that digitizes electromagnetic waveforms (e.g., microwave or radio-frequency) or optical signals, and a digitized waveform can be delivered to the controllers 106A or to other signal hardware components. In some instances, the controllers 106A process the information from the signal hardware 104A and provide feedback to the signal hardware 104A; based on the feedback, the signal hardware 104A can in turn generate new control signals that are delivered to the quantum processor cell 102A.

In some implementations, the signal hardware 104A includes signal delivery hardware that interface with the quantum processor cell 102A. For example, the signal hardware 104A may include filters, attenuators, directional couplers, multiplexers, diplexers, bias components, signal channels, isolators, amplifiers, power dividers and other types of components. In some instances, the signal delivery hardware performs preprocessing, signal conditioning, or other operations to the control signals to be delivered to the quantum processor cell 102A. In some instances, signal delivery hardware performs preprocessing, signal conditioning or other operations on readout signals received from the quantum processor cell 102A.

The example controllers 106A communicate with the signal hardware 104A to control operation of the quantum processor unit 103A. The controllers 106A may include digital computing hardware that directly interface with components of the signal hardware 104A. The example controllers 106A may include processors, memory, clocks and other types of systems or subsystems. The processors may include one or more single- or multi-core microprocessors, digital electronic controllers, special purpose logic circuitry, e.g., an FPGA (field programmable gate array) or an ASIC (application specific integrated circuit), or other types of data processing apparatus. The memory may include any type of volatile or non-volatile memory, a digital or quantum memory, or another type of computer storage medium. The controllers 106A may include additional or different features and components.

In some implementations, the controllers 106A include memory or other components that store quantum state information, for example, based on qubit readout operations performed by the quantum processor unit 103A. For instance, the states of one or more qubits in the quantum processor cell 102A can be measured by qubit readout operations, and the measured state information can be stored in a cache or other type of memory system in or more of the controllers 106A. In some cases, the measured state information is used in the execution of a quantum algorithm, a quantum error correction procedure, a quantum processor unit (QPU) calibration or testing procedure, or another type of quantum process.

In some implementations, the controllers 106A include memory or other components that store quantum machine instructions, for example, representing a quantum program for execution by the quantum processor unit 103A. In some cases, the quantum machine instructions are received from the server 108 in a hardware-independent format. For example, quantum machine instructions may be provided in a quantum instruction language such as Quil, described in the publication “A Practical Quantum Instruction Set Architecture,” arXiv:1608.03355v2, dated Feb. 17, 2017, or another quantum instruction language. For instance, the quantum machine instructions may be written in a format that can be executed by a broad range of quantum processor units or quantum virtual machines.

In some instances, the controllers 106A can interpret the quantum machine instructions and generate a hardware-specific control sequences configured to execute the operations proscribed by the quantum machine instructions. For example, the controllers 106A may generate control information that is delivered to the signal hardware 104A and converted to control signals that control the quantum processor cell 102A.

In some implementations, the controllers 106A include one or more clocks that control the timing of operations. For example, operations performed by the controllers 106A may be scheduled for execution over a series of clock cycles, and clock signals from one or more clocks can be used to control the relative timing of each operation or groups of operations. In some cases, the controllers 106A schedule control operations according to quantum machine instructions in a quantum computing program, and the control information is delivered to the signal hardware 104A according to the schedule in response to clock signals from a clock or other timing system.

In some implementations, the controllers 106A include processors or other components that execute computer program instructions (e.g., instructions formatted as software, firmware, or otherwise). For example, the controllers 106A may execute a quantum processor unit (QPU) driver software, which may include machine code compiled from any type of programming language (e.g., Python, C++, etc.) or instructions in another format. In some cases, QPU driver software receives quantum machine instructions (e.g., based on information from the server 108) and quantum state information (e.g., based on information from the signal hardware 104A), and generates control sequences for the quantum processor unit 103A based on the quantum machine instructions and quantum state information.

In some instances, the controllers 106A generate control information (e.g., a digital waveform) that is delivered to the signal hardware 104A and converted to control signals (e.g., analog waveforms) for delivery to the quantum processor cell 102A. The digital control information can be generated based on quantum machine instructions, for example, to execute quantum logic operations, readout operations, or other types of control.

In some instances, the controllers 106A extract qubit state information from qubit readout signals, for example, to identify the quantum states of qubits in the quantum processor cell 102A or for other purposes. For example, the controllers may receive the qubit readout signals (e.g., in the form of analog waveforms) from the signal hardware 104A, digitize the qubit readout signals, and extract qubit state information from the digitized signals.

The other QPU 103B and its components (e.g., the quantum processor cell 102B, the signal hardware 104B and controllers 106B) can be implemented, and in some instances operate, as described above with respect to the QPU 103A; in some cases, the QPU 103B and its components may be implemented or may operate in another manner. Similarly, the remote QPU 103C and its components can be implemented, and in some instances operate, in analogous manner.

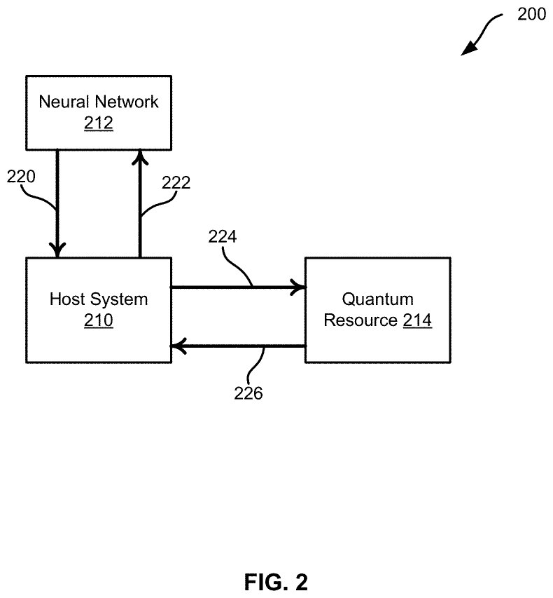

FIG. 2 is a schematic diagram showing resources in an example computing system 200. The example computing system 200 shown in FIG. 2 includes a host system 210, a neural network 212 and a quantum resource 214. The computing system 200 may include additional or different resources and components.

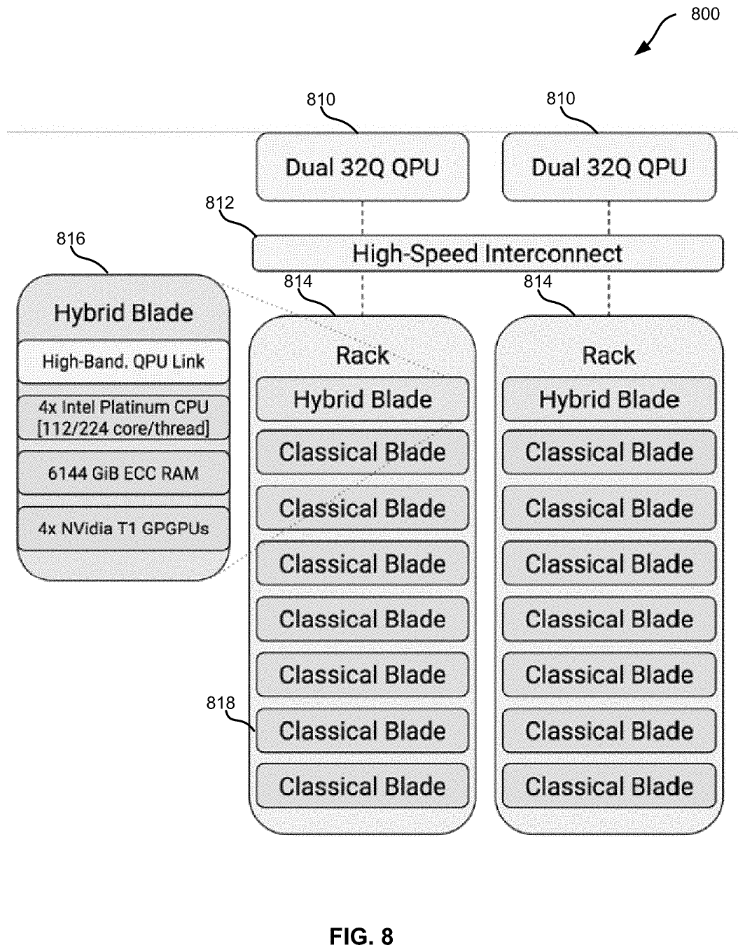

In some examples, the host system 210 and the neural network 212 can be implemented on a classical computing system, and the quantum resource 214 can be implemented as a quantum processor unit (QPU) or a quantum virtual machine (QVM). For instance, in the computing environment shown in FIG. 1, the host system 210 and the neural network may be implemented by one or more CPUs and GPUs included in the controllers 106A, and the quantum resource 214 may be implemented by the quantum processor unit 103A. The example resources shown in FIG. 2 can be implemented in another manner and in other types of computing environments. For instance, the host system 210 and neural network 212 may be implemented by the server 108 or the other computing resources 107, and the quantum resource 214 may be implemented by one or both of the quantum processor units 103A, 103B. In addition, FIG. 8 shows additional examples of hardware resources that may be used to implement the resources and operations shown in FIG. 2.

The example resources shown in FIG. 2 provide an example framework for utilizing a classical statistical model such as a neural network to generate quantum algorithms for solving problems on quantum computers. A problem to be solved can be formulated and provided as an input, and the neural network 212 can learn how to program the quantum computer to solve the problem. In some implementations, the problem to be solved by the quantum program is initially encoded. For example, the problem may be encoded into an equivalent problem that has a form or structure that can be represented on the quantum computer. In some cases, encoding is not necessary, for example, when the initial form or structure of the problem can be directly or trivially represented on the quantum computer. In some cases, an encoding process is needed to transform the problem from a natural problem space to a quantum computational problem space. For instance, electron configurations can be encoded using a technique such as the Bravyi-Kitaev algorithm. In some examples, encoding schemes may be configured to make more economic use of qubits or other attributes of quantum resources. Other types of encoding schemes may be used.

In the example shown in FIG. 2, the neural network 212 is constructed and trained using a machine learning algorithm. For instance, the neural network 212 can be trained by a transfer learning algorithm, a reinforcement learning algorithm, a deep learning algorithm, an asynchronous reinforcement learning algorithm, a deep reinforcement learning algorithm or another types of machine learning algorithm. In some embodiments, transfer learning algorithms train a smaller neural network to solve smaller problems, and the results of the smaller neural network are fed to a larger neural network. In some embodiments, transfer learning is immediately applicable to extending models across “domains”—for example, a model can be trained for MaxCut, then this model can be used to efficiently train a model for the Traveling Salesperson Problem. Asynchronous reinforcement learning algorithms typically train multiple smaller neural networks (e.g., in parallel) and combine the smaller neural networks to form a larger neural network. Reinforcement learning algorithms map a (state, reward) to an action, for example, through a look-up table. Deep reinforcement learning algorithms use a neural network to map a (state, reward) to an action.

Table 1 below provides example elements of a deep reinforcement learning algorithm that can be used by the computer system 200 to synthesize quantum programs. In this example, the elements shown in the table define an agent and a learning environment for a deep reinforcement learning process. In particular, the action, reward, state, and solved elements shown in Table 1 represent the learning environment, while the policy shown in Table 1 represents the agent. The policy provides the model by which the agent chooses to take a particular action, given a state, reward pair.

TABLE 1

| | Quantum Program Synthesis |
|---|---|
| Action | Apply a gate |
| Reward | Hamiltonian expectation value |
| State | State probabilities, graph |
| Solved | Hamiltonian expectation value is maximized |
| Policy | Neural network |

As shown in the right column of Table 1, in an example deep reinforcement learning process for quantum program synthesis, an action of an agent corresponds to applying a quantum logic gate to a quantum logic circuit; the reward corresponds to a Hamiltonian expectation value; the state corresponds to state probabilities and a graph; the solved criterion corresponds to the Hamiltonian expectation value being maximized, and the policy of the agent corresponds to a neural network. In some cases, the elements of a deep reinforcement learning process may be used in another manner for quantum program synthesis.

A publication entitled “Automated quantum programming via reinforcement learning for combinatorial optimization” (by Keri A. McKiernan, Erik Davis, M. Sohaib Alam, and Chad Rigetti; submitted to arXiv.org on Aug. 21, 2019; available at https://arxiv.org/abs/1908.08054v1; referred to hereafter as “Arxiv 1908.08054v1”), which is hereby incorporated by reference, describes example implementations of deep reinforcement learning for quantum program synthesis and example methodologies for incentive-based programming of hybrid quantum computing systems. The example methodologies provided in Arxiv 1908.08054v1 are applied to solve combinatorial optimization problems (COPs) via hybrid quantum computing systems, and the methodologies may also be applied to solve other types of problems and to build other types of quantum programs.

To apply reinforcement learning to solve a combinatorial optimization problem (COP) using quantum resources, Arxiv 1908.08054v1 provides an example of the state and action spaces, the reward, as well as the learning agent. In the case of COPs, the reward can [symbol] be specified as the cost Hamiltonian's expectation value, [symbol] ψ|H_{C}| [symbol] . The action space [symbol] can be specified as a finite set of quantum gates, such as a discretized set of RZ and RY rotation gates. Other types of state and action spaces, and another type of reward may be used in some instances. The example provided in Arxiv 1908.08054v1 focuses on the PPO (Proximal Policy Optimization) algorithm applied to a shared actor-critic agent. Using these identifications, the ability of PPO to solve a variety of COPs is demonstrated as an example.

A reinforcement learning problem is typically specified as a Markov Decision Process (MDP), in which the goal of the learning agent is to find the optimal policy. The optimal policy can be described as the conditional probability π*(a|s) of applying a particular quantum gate (action a) given a particular representation of the qubit register (state s) that would maximize the expected (discounted) return, which may be expressed as [symbol] _{π}[Σₖ₌₀^{∞}γ^{k}Rₖ₊₁], without necessarily having a model of the environment p(s′, r|s, a). In the expression of the expected return above, the expression [symbol] _{π} denotes the mathematical expectation over all possible probabilistic outcomes (as determined by the policy); the discount factor γ may be any number between 0 and 1, and causes the agent to prefer higher rewards earlier rather than later. The variable Rₖ₊₁ represents the reward observed in stage k+1 of the decision process. The model p(s′, r|s, a) refers to the conditional probability of observing state s′ and receiving reward r given that the agent performs action a in the state s. Defining the value of a state s under a policy π as

V_{π}(s)= [symbol] _{π}[Σₖ₌₀^{∞}γ^{k}Rₜ₊ₖ₊₁|Sₜ=s] (1)

the optimal policy can be identified more concretely as π* such that V_{π*}(s)>=V_{π}(s) for all states s and all policies π. In practice PPO will find some approximation to the theoretical optimum as a function of some parameters π*(a|s; θ)≈π*(a|s) which it will tune towards the optimum during the learning process.

The process of training an agent based on measurements from a quantum process can, in some cases, be modeled as a partially observed Markov Decision Process (POMDP), when quantum states are not themselves directly observable, and only their measurement outcomes are. While the action (quantum gate) that PPO chooses to carry out deterministically evolves the quantum state (in the absence of noise), the observation it receives from the measurement samples are in general not deterministic. For a single COP instance, the observations that PPO receives from the environment are some function of the sampled bitstrings from the measured quantum circuit. This function of the sampled bitstrings can be specified as the 2ⁿ Born probabilities |αᵢ|², subject to the normalization condition Σᵢ₌₀ⁿ^{²}⁻¹|αᵢ|²=1

s_{Born}: |ψ [symbol] →[|α₀|², . . . ,|α₂_{ⁿ}₋₁|²] (2)

which involves a specification of 2ⁿ−1 real numbers. For this example representation of the observation space, which is equivalent to the space of probabilistic bits, the optimal policy should disregard any phase information. For example, if the goal was to maximize [symbol] ψ|X|ψ [symbol] , it is sufficient to produce any of the states (1/\sqrt{2})(|0 [symbol] +e^{iθ}|1 [symbol] ), whichever one is cheapest to produce given a particular gateset. In cases where the Hamiltonians are diagonal in the computational basis, their solutions can be specified as some bitstring, which is equivalent to some computational basis element, and not necessarily a linear combination of such basis elements.

To extract quantum circuits from the trained agent on unseen problem instances of a COP, the state space can be augmented with a representation of the COP problem instance itself. For example, in the case of MAXCUT, the state description can include the graph whose maximum cut is sought. The RL agent can be trained over a collection of several such COP instances, forming the training set, and its predictions can be tested against a collection of similar but different COP instances that the agent has not seen before.

Three example COPs are considered in the examples described in Arxiv 1908.08054v1: MAXCUT, MAXQP, and QUBO (or UQBP). These problems can be described with respect to a weighted graph G=(V, E) on vertices V and edges E. The vertices may be numbered V={1, . . . , n}, with weights specified by a n x n real symmetric matrix w.

For the MAXCUT problem, the weights are non-negative values wᵢⱼ≥0, and wᵢⱼ is nonzero if there is an edge between vertices i and j. The maximum cut problem seeks a partition of V into two subsets such that the total edge weight between them is maximized. Formally,

$$MAXCUT \qquad {maximize}_{z ∈ {\{ - 1 , 1 \}}^{n}} \qquad \frac{1}{2} {\sum }_{i , j} {w}_{ij} \frac{1 - {z}_{i} {z}_{j}}{2} .$$

This problem is known to be NP-hard, although a number of polynomial-time approximation algorithms exist.

In some instances, solving the MAXCUT problem is equivalent to maximizing the expression Σ_{i<j} (−wᵢⱼ)zᵢzⱼ, where the coefficients (−wᵢⱼ) are always negative. The MAXQP problem can be considered a generalization of the MAXCUT problem, obtained by allowing the weights wᵢⱼ to have mixed signs. The resulting MAXQP problem, also NP-hard, is

$$MAXQP \qquad {maximize}_{z ∈ {\{ - 1 , 1 \}}^{n}} \qquad {\sum }_{i , j} {w}_{ij} {z}_{i} {z}_{j}$$

where w is a real symmetric matrix with null diagonal entries.

And the QUBO problem can be considered a generalization of the MAXQP problem, obtained by augmenting the quadratic expression Σ_{i,j} wᵢⱼzᵢzⱼ in the definition of MAXQP with an affine term (i.e. a term involving only single powers of z). The resulting QUBO (“quadratic unconstrained binary optimization”) problem can be given by

$$QUBO \qquad {maximize}_{x ∈ {\{ 0 , 1 \}}^{n}} \qquad {\sum }_{i , j} {w}_{ij} {x}_{i} {x}_{j}$$

where w is a real symmetric n×n matrix. The difference between xᵢxⱼ above (in MAXQP) and zᵢzⱼ(in MAXCUT) is the domain of the corresponding variables: {0,1} for xᵢ and {−1,1} for zᵢ. The above formulation of the QUBO problem is sometimes abbreviated as UQBP (“unconstrained quadratic binary program”). Under a transformation xᵢ=(1−zᵢ)/2, instances of the MAXCUT and MAXQP problem may be embedded as instances of the QUBO problem.

In the following discussion, C_{MaxCut} (C_{MaxQP}, CQUBO respectively) denote the objective functional in the MAXCUT problem (MAXQP, QUBO respectively) when expressed in terms of 0-1 binary variables and the weight matrix w. Using this notation, the maximum cut of a graph with weight matrix w is represented as max_{x∈{0,1}}_{ⁿ}C_{MaxCut}(x, w).

In the examples described in Arxiv 1908.08054v1, for each of these three example optimization problems (MAXCUT, MAXQP, QUBO), 16,000 random instances were generated; of these, 8,000 were used for training, 4,000 for validation, and 4,000 held out for testing. However, other sizes and types of problem sets may be used to train, validate and test a system. Also in the examples described in Arxiv 1908.08054v1, the number of variables is fixed at n=10, and the number of shots is fixed at m=10. However, in general any integer number of variables and shots may be used.

These example optimization problems (MAxCUT, MAXQP, QUBO) can be naturally mapped to quantum hardware, in the sense that a one-to-one correspondence between binary problem variables and qubits may be obtained. Thus for a problem of n variables, each basis vector of a n-qubit system may be expressed in ket notation as |b₁ . . . bₙ> where bᵢ∈{0,1}, and hence a single measurement of this system in the standard basis yields a candidate solution to the optimization problem.

In some cases, it is possible that the theoretical limit of the optimal program would be a series of X gates because the solution to these three example COPs is a bitstring (representing a computational basis element), and the gates I and X are sufficient to produce such states starting from the |0 [symbol] ^{⊗N} state. For these and other Hamiltonians consisting of diagonal terms such as ZᵢZⱼ, the shortest sequence of gates to produce the solution bitstring is a series of X gates on the appropriate qubits. A rotation of any angle other than π about the x-axis would produce a less than optimal value for the ZᵢZⱼ Hamiltonian, and therefore the reward, so that we cannot use the policy improvement theorem to improve upon this policy. For example, in some examples the Hamiltonian of the representation of the problem admits a diagonal form with respect to the computational basis, and after generating an updated version of the quantum program, the process is terminated if any angles of X rotation gates deviate from π by more than some threshold angle (e.g., π/2 radians or another threshold angle). The threshold angle (deviation from π) can be chosen to set a bound on how bad the program could be; with the choice of π/2 radians it will be within 2 times the length of the optimal program, and with a tighter choice this multiple can be reduced. By this same reasoning we obtain additional, problem-specific decision criteria, according to which the training process at any step may be terminated. If for a problem certain optimality conditions, such as the presence or absence of certain rotation gates in an optimal program, are known, then through a syntactic analysis of the programs produced by a policy one may determine whether improvement is possible. Likewise, if for a problem it is known by analytic or other means that an optimal policy imposes a certain classical complexity, either through a bound on the number of gates in an optimal program or on the magnitude of classical resources needed to evaluate the policy, then one may determine for certain problems whether a quantum speedup is feasible or infeasible.

In some implementations, the action space may be defined with the following example actions:
X, Y, and Z rotations on each qubit, with discrete angles

$$\frac{2 π k}{8} .$$

Controlled-not (CNOT) gates on each pair of distinct qubits.
   Thus, in this example there are 3*10*8=240 single qubit actions, and 45 two qubit actions. The action space may be defined in another manner. For example, the action space may include additional or different single-qubt quantum logic gates (e.g., rotations about different axes, a different discretization, continuous rotations, etc.), additional or different two-qubit quantum logic gates (e.g., discretized or continuous controlled-phase (CZ) gates, Bell-Rabi gates, etc.), or combinations of these and other types of quantum logic gates.

In some implementations, each of the actions in the action space (each quantum logic gate) can be expressed in the Quil Instruction Set Architecture (Quil ISA), and a sequence of actions (a quantum logic ciruict) may be expressed as a Quil program. Other instruction set architectures and programming languages may be used. When a sequence of actions is executed on a quantum device, a corresponding quantum state is prepared. A measurement of this state with respect to the standard computational basis results in a bitstring b=b₁b₂ . . . bₙ, where bᵢ was the measured state of qubit i. This process of preparation and measurement may be repeated for some number of times (the “number of shots”), resulting in a sequence of bitstrings. After number of shots m, the resulting observation of the quantum state is an m×n binary array B=[b⁽¹⁾; . . . ; b^{(m)}]. For example, if m=100 and n=10, the resulting observation of the quantum state is a 100×10 binary array B=[b⁽¹⁾; . . . ; b⁽¹⁰⁰⁾].

In some implementations, a problem instance may be specified by a specific choice of weights w. For MaxCut and MaxQP, the

$$( \begin{matrix}n \\ 2\end{matrix} )$$

off-diagonal upper triangular entries of the weight matrix w suffice to fully describe the problem instance. For QUBO, the

$$( \begin{matrix}n \\ 2\end{matrix} ) + n$$

upper triangular entries are used. These may be concisely expressed as a numeric vector \tilde{w}, representing an observation of the problem instance. The observation made by the agent may include the joint quantum and problem observations obs:=(B, \tilde{w}).

In some implementations, the reward may be defined with respect to the joint quantum and problem observations. For instance, with respect to a given problem of the form max_{x∈{0,1}}_{ⁿ}C(x), the reward associated with the observation obs can be given by

$$r ( obs ) = \frac{1}{m} {\sum }_{i = 1}^{m} C ( {b}^{( i )} ) .$$

This may be seen to be an estimate of the expectation of the corresponding problem Hamiltonian. The reward may be defined in another manner in some cases.

Because the quantum and problem observations are of a distinct nature, the policy architecture may treat them differently. With respect to the quantum observation, the bitstrings {b⁽ⁱ⁾}ᵢ₌₁^{m} form an exchangeable sequence. To capture this permutation-invariance of measurement statistics, an initial layer may be considered using the framework of “Deep Sets.” A neural network typically reprsents a sequence of mathematical transformations, mapping an input (e.g., an input vector) to an output (e.g., an output vector). These transformations (often referred to as layers) are typically parameterized by (1) weights that characterize a linear portion of the transformation and and (2) activation functions that are typically nonlinear and have the effect of making the composition of layers nontrivial. In this context, the initial layer is the first transformation applied to the measured bitstrings {b⁽ⁱ⁾}ᵢ₌₁^{m}. The framework of “Deep Sets” (see Manzil Zaheer et al., “Deep sets,” Advances in neural information processing systems, 2017, pp. 3391-3401) suggests a form for what the initial layer should look like in the case where the input has certain symmetries. As a special case, in some examples, we let the initial input layer [symbol] be defined by

$$v ( obs ; Θ ) := ρ ( \frac{1}{m} {\sum }_{i = 1}^{m} Θ {b}^{( i )} ) ,$$

where Θ is a l×n matrix of weights for the first layer of the neural network, and ρ is a nonlinear activation function (e.g., ρ=tanh). In this example, v is able to capture first-order statistics of the observed bitstrings via the trainable weights Θ. In some cases, the linear term in the above expression for v can be extended with higher terms, corresponding to higher-order statistics of the underlying Born probabilities.

In some implementations, the initial observation (B, \tilde{w}) is transformed to (v(obs; Θ), \tilde{w}), which is then concatenated to a single vector and subsequently passed through a neural network, and the output of the neural network is a vector of action scores. In some cases, the number of weights in the full neural network may scale as some small polynomial in the number of problem variables n. For learning, an actor-critic PPO may be used. In some implementations, a single neural network serves as a shared actor and critic network, and the weights for both the dense layers (i.e., those layers other than the initial layer v) as well as those for measurement statistics (i.e., the weights for the initial layer v, which serve to translate a set of measured bitstrings to some reduced form) can be trained. Actor-critic algorithms represent a class of reinforcement learning algorithms that involve the estimation of both an optimal policy function (the “actor”) as well as an optimal value function (the “critic”). Typically both of these functions are represented via neural-networks, and in the case of shared actor-critic methods these neural networks may have some subset of their weights shared in common.

The examples described above and in Arxiv 1908.08054v1 can be applied to more programming tasks, deeper investigation of input and observation featurization techniques, larger or continuous action spaces, modifications of the reward, training different agent types, analysis of output sequences and other variations. For instance, the input problems can be represented via their “weight matrices” as described above, or another representation may be used, for example, any of the many vectorized representations commonly used in the literature on “Graph Neural Networks,” which may affect end-to-end performance. Examples of other agents and learning algorithms that may be used include “Deep Q Networks,” “Deep Deterministic Policy Gradient,” and “Trust Region Policy Optimization” among others.

For example, applying the methodology to other problems (problems other than the three example COPs described above), such as those found in quantum simulation settings where Hamiltonians are in general non-diagonal in the computational basis, would yield theoretically optimal policies that use non-Clifford operations. By changing the reward structure, the methodology can be further optimized not just for shortest sequence of gates from some given gateset, but also to preferentially utilize quantum resources over classical ones. Moreover, the choice of observation space and policy architecture can be modified for more general problems (e.g. as may arise in qauntum chemistry). For example, it may be useful or even necessary for the observation to include measurements with respect to several bases; and the policy in such cases should be modified accordingly.

In the example shown in FIG. 2, the host system 210 acts as the agent and the neural network 212 acts as the policy. At 220, the host system 210 performs an action (applies gates to the quantum circuit) according to its policy (the neural network 212). For example, the host 210 may receive neural network output data from the neural network 212, which may include an identification of a particular quantum logic gate that has been selected, or a distribution of values that the host 210 can use to select a particular quantum logic gate. The selected quantum logic gate can then be appended to an existing quantum logic circuit.

At 224, the host system 210 provides the current version of the quantum logic circuit to the quantum resource 214 to be executed. At 226, the host system 210 receives quantum processor output data from the quantum resource 214 based on the quantum resource's execution of the current version of the quantum logic circuit. The host system 210 may compute the reward (expectation value of the Hamiltonian of interest) and state (state probabilities and graph of interest) based on the quantum processor output data. At 222, the host system uses the state and the reward to update the parameters of the neural network 212, to define inputs to the neural network 212, or both.

The example operations (220, 224, 226, 222) shown in FIG. 2 may be iterated until a terminating condition is reached. For example, the deep reinforcement learning process may be configured to iterate until the performance of the agent ceases to improve (according to the “solved” criterion), until the quantum program reaches a certain length, until a certain number of iterations have been performed, etc. In some examples, the agent is given no information regarding quantum computing or quantum gates, and the agent learns a sequence of gates strictly through experience.

The example resources and operations shown in FIG. 2 can be used to solve a variety of optimization problem types. In some cases, the resources and operations shown in FIG. 2 can be applied to a variety of combinatorial optimization problems (COPs), for example, those that are reducible to Maximum Cut (“MaxCut”), including any of the twenty-one example COPs, known as “Karp's 21 problems,” which are described in the publication entitled “Reducibility among Combinatorial Problems” (by Richard M. Karp, in Complexity of Computer Computations, edited by R. E. Miller and J. W. Thatcher (New York: Plenum, 1972) pp. 85-103): (1) the satisfiability problem, (2) the 0-1 integer programming problem, (3) the clique problem, (4) the set packing problem, (5) the node cover problem, (6) the set covering problem, (7) the feedback node set problem, (8) the feedback arc set problem, (9) the directed Hamilton circuit problem, (10) the undirected Hamilton circuit problem, (11) the satisfiability with at most 3 literals per clause problem, (12) the chromatic number problem, (13) the clique cover problem, (14) the exact cover problem, (15) the hitting set problem, (16) the Steiner tree problem, (17) the three-dimensional matching problem, (18) the knapsack problem, (19) the job sequencing problem, (20) the partition problem, and (21) the Maximum Cut problem. The example resources and operations shown in FIG. 2 may also be useful for solving other types of optimization problems, such as, for example, optimization problems in quantum chemistry (e.g., finding the ground state energy of a molecule).

The MaxCut COP is an example of an optimization problem for which quantum programs can be synthesized using the techniques and systems described here. In the MaxCut COP, the vertices of a graph are partitioned into two sets, such that the sum over the weighted edges connecting the two partition is maximal. The MaxCut corresponds to the bitstring that maximizes the value of the following Hamiltonian:

$${H}_{MaxCut} = {\sum }_{i , j ∈ E} {w}_{ij} ( I - {Z}_{i} {Z}_{j} )$$

Applying a deep reinforcement learning framework to produce a quantum program that solves the MaxCut problem on a quantum computer, the desired Hamiltonian and a set of quantum logic gates from which the agent can choose are specified.

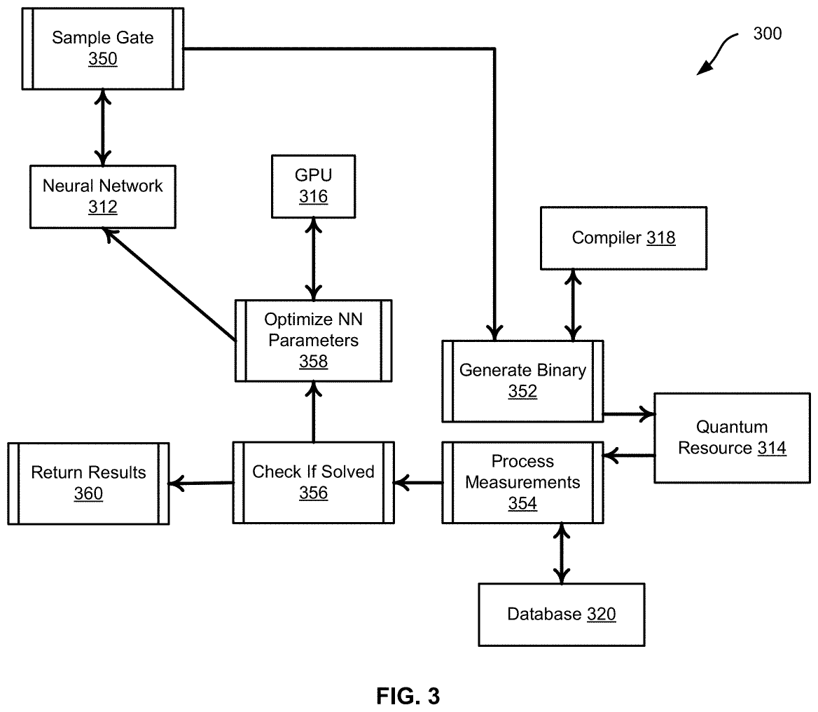

FIG. 3 is a flow diagram of an example process 300 for synthesizing quantum logic circuits. The example process 300 includes example operations (represented by the boxes with sidebars in FIG. 3) that are executed by a computer system (e.g., a CPU or another type of computer resource) acting as an agent in a deep reinforcement learning process. As shown in FIG. 3, in executing the process 300, the agent interacts with a neural network 312, a quantum resource 314, a graphics processing unit (GPU) 316, a compiler 318, and a database 320. The agent may interact with additional or different systems or components, and may perform additional or different operations in some instances.

The example process 300 in FIG. 3 can be used to train the agent. In the training process, the agent is allowed to choose from a finite set of discrete quantum logic gates, and the process 300 is run for many different graphs, each sampled from a large training dataset of random graphs. Each graph represents a specific optimization problem to be solved by a quantum program. Running this process for many graph types will typically help with generalizability to arbitrary unseen graphs.

At a high level, on each iteration, the agent selects a quantum logic gate from the set of allowable quantum logic gates and appends this quantum logic gate to the end of the current program (which specifies a quantum logic circuit). The set of allowable quantum logic gates may include any combination of parametric gates, non-parametric gates, single-qubit gates, two-qubit gates, etc. The selection of the quantum logic gate on each iteration is determined by the agent's policy, which is given by the classical neural network 312. In some examples, this selection is initially uniform over the gate set (e.g., in the initial iteration); other initialization conditions may be used. Through the training process, the parameters of the neural network 312 are updated such that this selection becomes increasingly strategic.

At 350, the agent samples the neural network 312 to select a quantum logic gate. To sample the neural network, the agent operates the neural network, for example, on a classical computing resource. In some examples, the agent provides neural network input data to the neural network, the neural network then processes the neural network input data to produce neural network output data, and the agent receives the neural network output data.

In the example shown in FIG. 3, the neural network input data include the “state” and “reward” information shown in Table 1. For example, the neural network input data may include state probabilities or other quantum state information. The quantum state information represents the quantum state produced by a current version of the quantum program that is being synthesized by the process 300. The quantum state can be represented, for example, by state probabilities (e.g., an empirical probability distribution), a statistical characterization (mean, variance, high order moments, etc.), or other parameters. In some cases, on the initial iteration of the process 300, the initial version of the quantum program is the identity circuit, and the quantum state information provided to the neural network corresponds to the identity state. Other initialization conditions may be used.

The neural network input data may also include a representation of the problem to be solved by the quantum program. In some implementations, the problem to be solved is represented by an adjacency matrix or another type of data structure. The adjacency matrix corresponds to a specific optimization problem, for example, the graph representation of a specific MaxCut problem or another combinatorial optimization problem, or the geometry (e.g., connectivity and bond lengths) of a molecule or another quantum chemistry optimization problem.

The neural network input data may also include the reward computed based on the current version of the quantum program that is being synthesized by the process 300. For example, the reward can be a Hamiltonian expectation value or another type of cost function value.

In the example shown in FIG. 3, the neural network output data includes a set of values associated with the set of allowable quantum logic gates. The set of values may be viewed as a probability distribution, where the value associated with each quantum logic gate represents a probability that (or a prediction of the degree to which) the quantum program will be improved by appending that quantum logic gate to the quantum program. In some implementations, the agent uses the set of values to select one of the allowable quantum logic gates. For example, the agent may identify the maximum value (representing the maximum probability of improving the quantum program) and choose the quantum logic gate associated with the maximum value. Or the agent may introduce randomness by sampling the probability distribution stochastically, such that gates associated with higher values are chosen with higher probability.

After the agent has selected a quantum logic gate at 350, the agent updates the quantum program to include the selected quantum logic gate. For example, the quantum program may be represented as a quantum logic circuit that includes a series of quantum logic gates, and the selected quantum logic gate can be appended to the end of the series. The selected quantum logic gate may be added to the quantum program in another manner in some cases. In some instances, appending the selected quantum logic gate to the series improves the quantum program, for example, causing the quantum program to produce a higher value of the “reward” (e.g., as shown in Table 1) defined by the problem to be solved by the quantum program.

At 352, the agent compiles the current version of the quantum program. In some examples, the un-compiled quantum program includes instructions expressed in quantum machine instruction language (e.g., Quil), or instructions expressed in another language (e.g., pyQuil) that generates quantum machine instructions. In the example shown in FIG. 3, the compiled quantum program includes instructions expressed as binary machine code. The compiled quantum program may include instructions expressed in another format.

The agent then provides the compiled quantum program to the quantum resource 314, which then executes the compiled current version of the quantum program. In some cases, the quantum resource 314 is a quantum processor unit (QPU) or a quantum virtual machine (QVM). In some cases, the quantum resource 314 is a set of multiple QPUs or QVMs that run multiple instances of the quantum program (e.g., in parallel).

In some cases, the quantum resource 314 may execute the quantum program many times (e.g., hundreds, thousands, millions of times) to obtain quantum state information representing the quantum state produced by the quantum program. For example, the number of iterations may be based on the number of measurements needed to obtain a statistically meaningful representation of the quantum state.

At 354, the agent receives and processes quantum processor output data from the quantum resource 314. In the example shown, the agent receives measurements generated by the quantum resource 314 executing the current version of the quantum program, and computes “state” and “reward” information (e.g., according to Table 1 or otherwise) from the measurements. The reward information can be computed by evaluating a cost function (e.g., a cost function based on the Hamiltonian specified by the problem to be solved). For example, the agent may compute the empirical probability distribution in order to update the state; and the agent may evaluate the empirical expectation value of the MaxCut Hamiltonian. In some cases, the reward value can be computed faster, for example, by looking up the bitstring to precomputed reward values in the database 320.

At 356, the agent checks if the reward satisfies the “solved” criteria (e.g., as specified in Table 1 or otherwise). For example, the agent may check to see if the reward value is greater than a threshold (for a maximization problem) or less than a threshold (for a minimization problem). As an example, the agent may check to see if the Hamiltonian expectation value is exactly one, which occurs when the quantum program gives the optimal bitstring with 100% certainty (e.g., each bitstring sampled is the MaxCut). Other, less onerous conditions may be used. If the reward does satisfy the “solved” criteria at 356, then the agent returns the results at 360. The results returned by the agent may include the version of the quantum program produced by the final iteration of the process 300.

If the reward does not satisfy the “solved” criteria at 356, then at 358, the agent modifies the parameters of the neural network 312. The neural network is updated based on the “state” and “reward” data computed from the quantum processor output data at 354. Various techniques may be used to update the neural network 312. In some cases, the neural network 312 is updated according to a deep reinforced learning (DRL) algorithm used by the process 300. Examples of DRL algorithms include A2C, A3C ACER, ACKTR, DDPG, DQN, GAIL, HER, PPO, SAC, TRPO and others.

In some examples, the PPO algorithm described in “Proximal Policy Optimization Algorithms” (by J. Schulman, et al., arXiv:1707.06347v2 [cs.LG] 28 Aug. 2017) is used to update the neural network 312. Using the PPO algorithm in the process 300, an input vector (state, reward) that includes the “state” and “reward” data from the last n steps (where n is an integer greater than or equal to 1) is provided as input for updating the neural network 312. The input vector can be of length one (i.e., n=1), specifying the most recent (state, reward) pair, or it can be longer (n>1) and include a “memory” over the last several (state, reward) pairs. The input vector is used to compute a loss function, and derivatives of the loss function are taken with respect to each parameter of the neural network. The derivatives are used to update the parameters of the neural network, for example, according to an optimization technique such as stochastic gradient descent or otherwise.

In many cases, one or more GPUs are used to update the neural network. In the example shown in FIG. 3, the GPU 316 is used to compute updated parameters for the neural network, and the agent updates the neural network 312 based on the new parameters computed by the GPU 316. GPUs often provide greater computational speed and efficiency in the context of updating a neural network. For example, GPUs may be useful because the update process typically involves many computationally expensive operations, such as pushing significant amounts of data through the neural network and computing many derivatives. In addition, some existing software packages for updating neural networks (tensorflow, pytorch, etc.) have been optimized to run on GPUs.

After the parameters of the neural network 312 have been modified, the agent executes another iteration of the process 300. For example, each iteration of the iterative process may include: operating the updated neural network to produce neural network output data for the iteration based on the current “state” and “reward” information (at 350); selecting a quantum logic gate for the iteration based on the neural network output data (at 350); generating an updated version of the quantum program that includes the selected quantum logic gate for the iteration (at 350); compiling the quantum program for the iteration (at 352); generating quantum processor output data for the iteration by executing the quantum program; computing quantum state information and reward information for the iteration based on the quantum processor output data (at 354); and updating the neural network (at 358) if the “solved” criteria are not met. As such, in each iteration, a new version of the quantum program is generated based on the updated neural network, and the quantum resource 314 executes the new version of the quantum program.

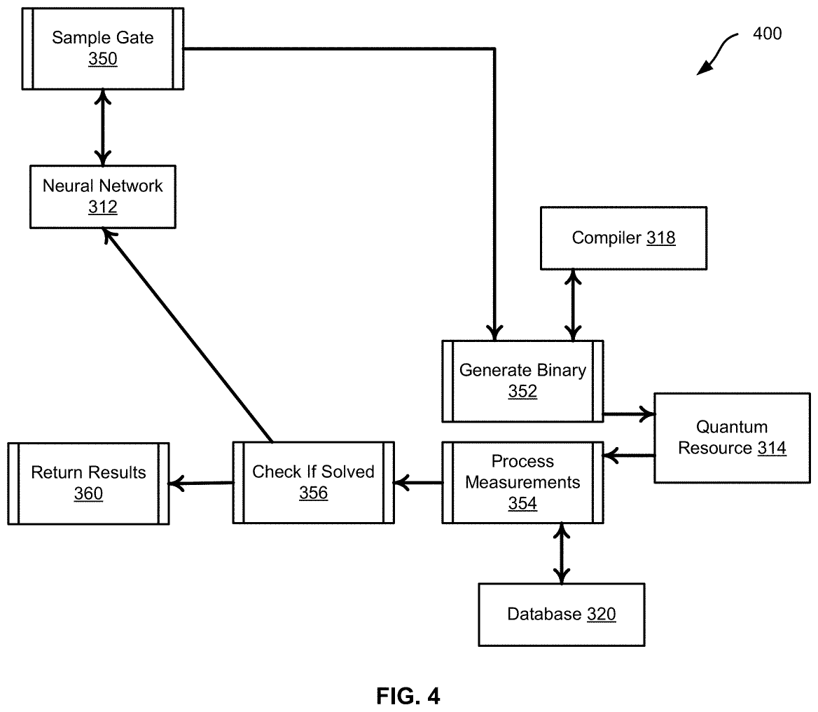

FIG. 4 is a flow diagram of another example process 400 for synthesizing quantum logic circuits. The example process 400 in FIG. 4 is similar to the example process 300 in FIG. 3, except that operation 358 is omitted and therefore the neural network 312 is not trained (or otherwise modified) by the process 400. Accordingly, the process 400 in FIG. 4 can be used to sample the neural network 312 after the neural network 312 has been trained (e.g., by the process 300 in FIG. 3 or otherwise). As shown in FIG. 4, if the reward does not satisfy the “solved” criteria at 356, then the agent provides the “state” and “reward” information to the neural network 312 for the next iteration of the process 400.

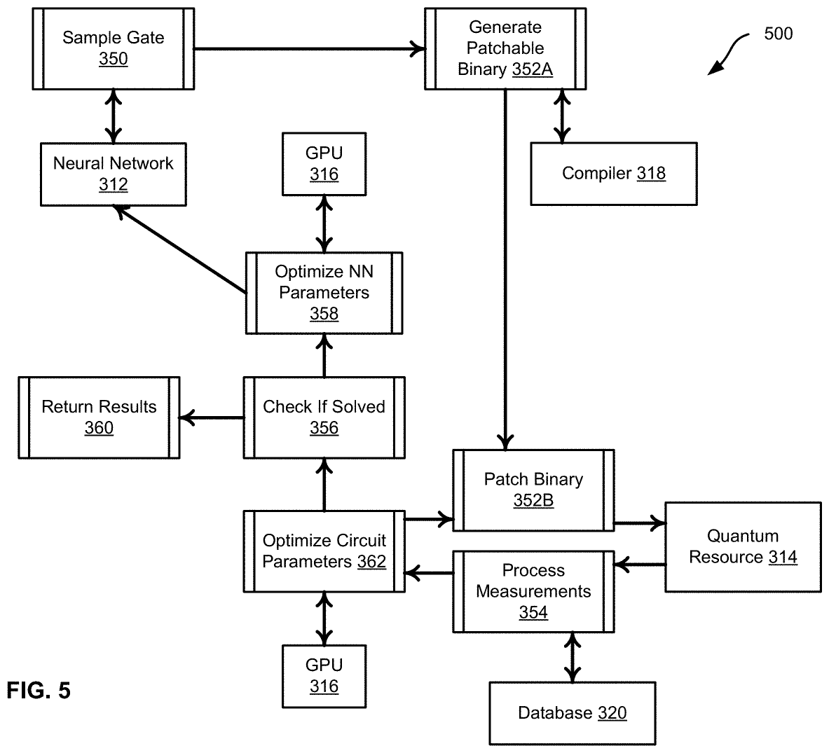

FIG. 5 is a flow diagram of another example process 500 for synthesizing quantum logic circuits. The example process 500 in FIG. 5 is similar to the example process 300 in FIG. 3, except that the operation 352 (in FIG. 3) is divided into two operations 352A, 352B (in FIG. 5) and an additional operation 362 is included to allow the agent to use parametric quantum logic gates. Accordingly, the process 500 in FIG. 5 can be used to train the neural network 312 in cases where the set of allowed quantum logic gates includes parametric gates.

In the example shown in FIG. 5, at 350 the agent can choose from a set of quantum logic gates that includes one or more parametric gates. The parametric gates are quantum logic gates that are defined in terms of a variable parameter. For instance, a rotation gate Rₓ(θ) rotates a qubit about the x-axis by an angle θ, which is a variable parameter of the gate. As another example, a controlled-rotation gate rotates a target qubit conditionally on the state of a control qubit about an axis by an angle θ, which is a variable parameter of the gate. As such, the updated version of the quantum program may be generated at 350 with a variable parameter (e.g., a variable rotation angle or another type of variable parameter).

At 352A, the quantum program with unspecified values for one or more variable parameters is compiled by the compiler 318. In the example shown, the compiler 318 generates a patchable binary machine code, which is an example of a compiled quantum program in which definite values of the variable parameters have not yet been specified. At 352B, definite values of the variable parameters are selected, and the patchable binary machine code is patched to generate the full, compiled quantum program.

At 362, the agent optimizes the variable parameters in the quantum program. For example, the agent may use the GPU 316 to determine an updated value for one or more variable parameters to improve performance of the quantum program. In some cases, the agent iterates an optimization loop (352B, 354, 362) to modify the value of the variable parameter until a terminating condition is reached (e.g., threshold number of iterations has been reached, and incremental improvement between iterations is below a threshold, or otherwise). On each iteration of the internal optimization loop, the patchable binary machine code (from 352A) is patched based on new values for the variable parameters (from 362) to generate a new compiled version of the quantum program. The agent then obtains (at 354) additional quantum processor output data generated by the quantum resource 314 executing the new compiled version of a quantum program, and the agent the selects (at 362) new values for the variable parameters based on the additional quantum processor output data.

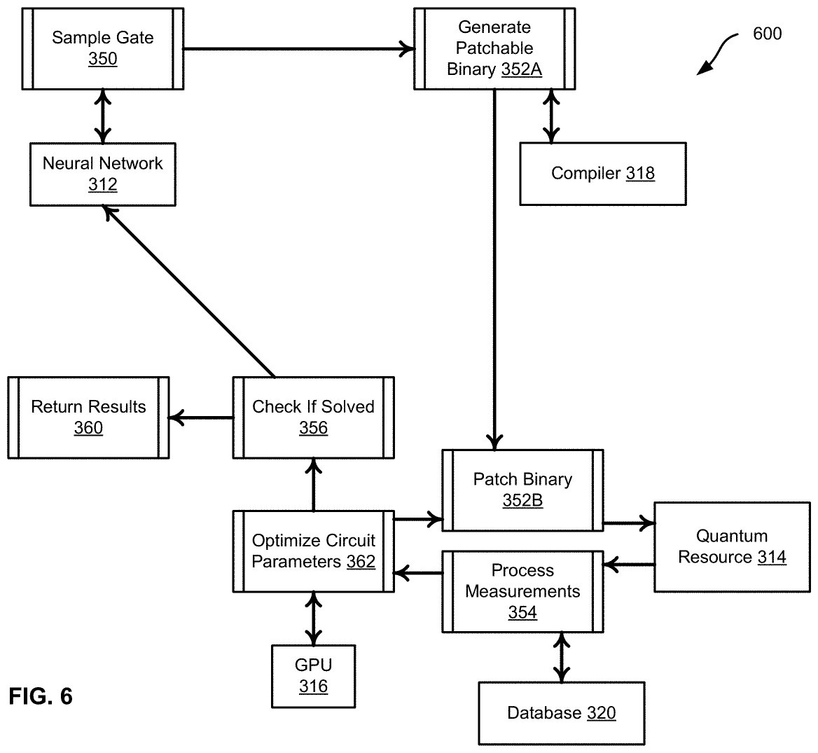

FIG. 6 is a flow diagram of another example process 600 for synthesizing quantum logic circuits. The example process 600 in FIG. 6 is similar to the example process 500 in FIG. 5, except that operation 358 is omitted and therefore the neural network 312 is not trained (or otherwise modified) by the process 600. Accordingly, the process 600 in FIG. 6 can be used to sample the neural network 312 after the neural network 312 has been trained (e.g., by the process 500 in FIG. 5 or otherwise). As shown in FIG. 6, if the reward does not satisfy the “solved” criteria at 356, then the agent provides the “state” and “reward” information to the neural network 312 for the next iteration or the process. Also shown in FIG. 6, the internal optimization loop (362, 352B, 354) is preserved so that the parameters of parametric gates can be optimized upon each iteration, as in the example process 500.

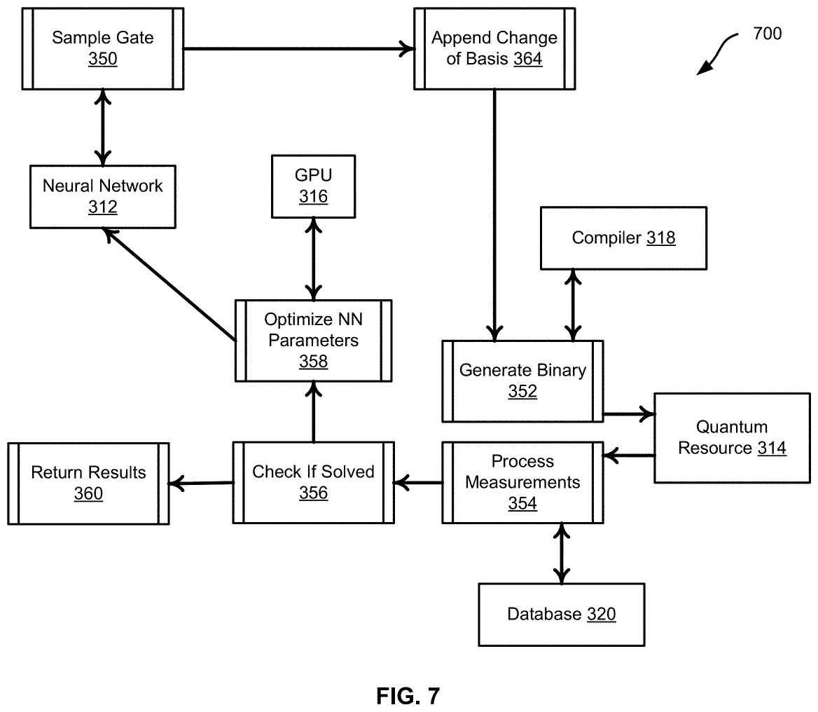

FIG. 7 is a flow diagram of another example process 700 for synthesizing quantum logic circuits. The example process 700 in FIG. 7 is similar to the example process 300 in FIG. 3, except that an additional operation 364 is included to allow the agent to solve problems expressed in an arbitrary basis. Accordingly, the process 700 in FIG. 7 can be used to train the neural network 312 for problems where the relevant Hamiltonian is not diagonal in the computational basis of the quantum resource 314.

Typically, the MaxCut Hamiltonian can be represented as a diagonal operator in a computational basis, and therefore, the change of basis operator would not typically be necessary for quantum programs synthesized to solve the MaxCut problem. However, the change of basis operator may be needed in certain quantum chemistry applications, or other optimization problems that cannot conveniently be expressed as a diagonal operator in the computational basis.

As shown in FIG. 7, at 364, a change of basis operation is appended to the updated version of the quantum program in each iteration. The change of basis operation is determined by the Hamiltonian associated with the problem that the quantum program is being synthesized to solve, and therefore, the same change of basis operation can be appended to the quantum program in each iteration for the same problem. When a new problem is defined, the change of basis operation can be updated accordingly.

FIG. 8 is a diagram showing hardware elements in an example computing system 800. The example computing system 800 includes two QPU systems 810, a high-speed interconnect 812, and two control racks 814. Each control rack 814 includes a hybrid blade 816 and several classical blades 818. The computing system 800 may include additional or different features and components, and they may be configures as shown or in another manner.

The example computing system 800 in FIG. 8 shows example hardware components that may be used to implement the computing system 200 in FIG. 2. For example, the QPU systems 810 in FIG. 8 may be used as the quantum resource 214 in FIG. 2, and the control racks 814 in FIG. 8 may be used to implement the host system 210 and the neural network 212 in FIG. 2. The hardware elements shown in FIG. 8 can be used, in some instances, to execute various operations of a quantum program synthesis process in parallel.

Accordingly, the example computing system 800 in FIG. 8 may be used to perform one or more operations represented in the example processes 300, 400, 500, 600, 700 shown in FIGS. 3, 4, 5, 6, and 7. For example, the hybrid blade 816 (e.g., the CPU included in the hybrid blade 816) may perform the operations of the agent shown in FIGS. 3, 4, 5, 6, and 7. In addition, the hybrid blade 816 (e.g., the CPU included in the hybrid blade 816) may perform the operations of the compiler 318 and the neural network 312 in FIGS. 3, 4, 5, 6, and 7; the GPUs included in the hybrid blade 816 may perform the operations of the GPU 316 shown in FIGS. 3, 4, 5, 6, and 7; and the memory (RAM) included in the hybrid blade 816 may perform the operations of the database 320 shown in FIGS. 3, 4, 5, 6, and 7. In addition, the QPU systems 810 may perform operations of the quantum resource 314 shown in FIGS. 3, 4, 5, 6, and 7; and/or the classical blades 818 (e.g., operating as one or more QVMs) may perform operations of the quantum resource 314 shown in FIGS. 3, 4, 5, 6, and 7.

The example QPU systems 810 each include dual 32-qubit quantum processor units (QPUs). A dual 32-qubit QPU includes two independently-operated QPUs in the same controlled environment (e.g., on the same chip, in the same cryostat, or in another type of shared environment). The two independently-operated QPUs can be operated independently of each other, for example, to execute two instances of a quantum program in parallel.

Each of the QPU systems 810 is controlled by a hybrid blade 816 in a respective control rack 814. In particular, each hybrid blade 816 includes a high-band QPU link that communicates with the associated QPU system 810 through the high-speed interconnect 812. Each hybrid blade 810 also includes one or more CPUs (in the example shown, 4× Intel Platinum CPU [112/223 core/thread]), memory (in the example shown, 6144 GIB ECC RAM), and one or more GPUs (in the example shown, 4× NVidia T1 GPGPUs).

The classical blades 818 may be used to perform one or more operations of the agent in a training or sampling process in some instances. Additionally or alternatively, the classical blades 818 may be operated as one or more QVMs to perform operations of the quantum resource in a training or sampling process in some instances.

In some aspects of operation, the hybrid blade 816 picks a quantum logic gate from a set of allowable gates and appends the quantum logic gate to the end of the current program (e.g., operation 350 in FIGS. 3, 4, 5, 6, 7). The hybrid blade 816 may then compile the current program, for example, into binary machine code (e.g., operation 352 in FIGS. 3, 4, 7) or into patchable binary machine code (e.g., operation 352A in FIGS. 5, 6) and then patch the patchable binary machine code (e.g., operation 352B in FIGS. 5, 6). The hybrid blade 816 may then dispatch the compiled program to multiple QPUs, collect the quantum processor output data from the QPUs, and process the QPU measurements (e.g., operation 354 in FIGS. 3, 4, 5, 6, 7). In some cases, the hybrid blade 816 may dispatch the compiled program to QVMs provided by the classical blades 818, collect the quantum processor output data from the QVMs, and process the data (e.g., operation 354 in FIGS. 3, 4, 5, 6, 7). In some cases, the hybrid blade 816 may run a classical optimizer to update variable parameters of parametric gates (e.g., operation 362 in FIGS. 5, 6). The hybrid blade 816 or a classical blade 818 may then check if a reward satisfies the “solved” criteria and, if so, return a result (e.g., operations 356, 360 in FIGS. 3, 4, 5, 6, 7). The GPU of the hybrid blade 816 may be used to compute updated neural network parameters (e.g., operation 358 in FIGS. 3, 4, 5, 6, 7) for a subsequent iteration, for example, if the reward does not satisfy the “solved” criteria.

The two parallel QPU systems 810 and respective control racks 814 may be operated independently, for example, in parallel. For instance, each system may be used to train distinct neural networks in parallel, and the two neural networks may then be combined to form a larger neural network.

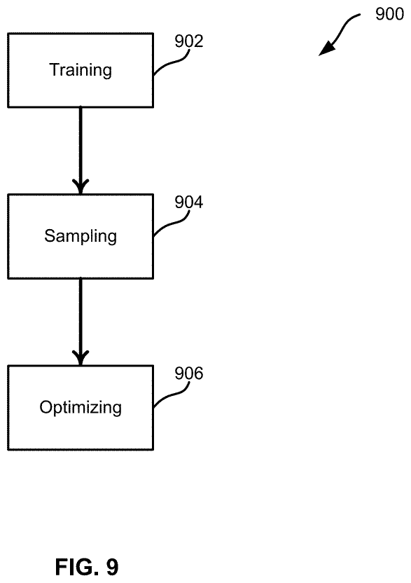

FIG. 9 is a flow diagram of an example process 900 for synthesizing quantum logic circuits. The example process 900 can be performed, for example, by the example computing system 200 shown in FIG. 2, the example computing system 800 shown in FIG. 8, or by another type of computing system.

At 902, a neural network is trained for synthesizing quantum programs. For example, the neural network may be trained using the example process 300 shown in FIG. 3, the example process 500 shown in FIG. 5, the example process 700 shown in FIG. 7, or another type of training process. The neural network may be trained based on one or more specific problems selected from a class of optimization problems (e.g., multiple MaxCut graphs may be used to train the neural network).

At 904, the neural network that was trained at 902 is sampled to synthesize a quantum program for a specific problem (e.g., a specific MaxCut graph). For example, the neural network may be sampled using the example process 400 shown in FIG. 4, the example process 600 shown in FIG. 6, or another type of sampling process.

At 906, further optimization may be applied to quantum programs or problem solutions generated at 902, at 904, or both. In some cases, a problem solution generated by the quantum program synthesized at 904 is further optimized. For example, the problem solution or the quantum program may be finely tuned using a cluster of QVMs or another type of quantum resource that has a low noise profile. Additionally or alternatively, the same type of fine tuning may be applied to problem solutions or quantum programs generated during the training process at 902.

In some cases, a “last mile optimization” applied at 906 may be useful, for example, in a computing environment where the low-noise quantum resources have a higher computational cost (e.g., longer processing time), and therefore, the low-noise quantum resources are deployed selectively for fine-tuning. The optimization process at 906 may be applied to improve parameters of the neural network, to improve accuracy of the quantum state information or expectation values (or any other “reward” or “state” information) generated by a quantum program, values of parameters for parametric gates in the quantum program, or other attributes of the quantum programs or problem solutions.

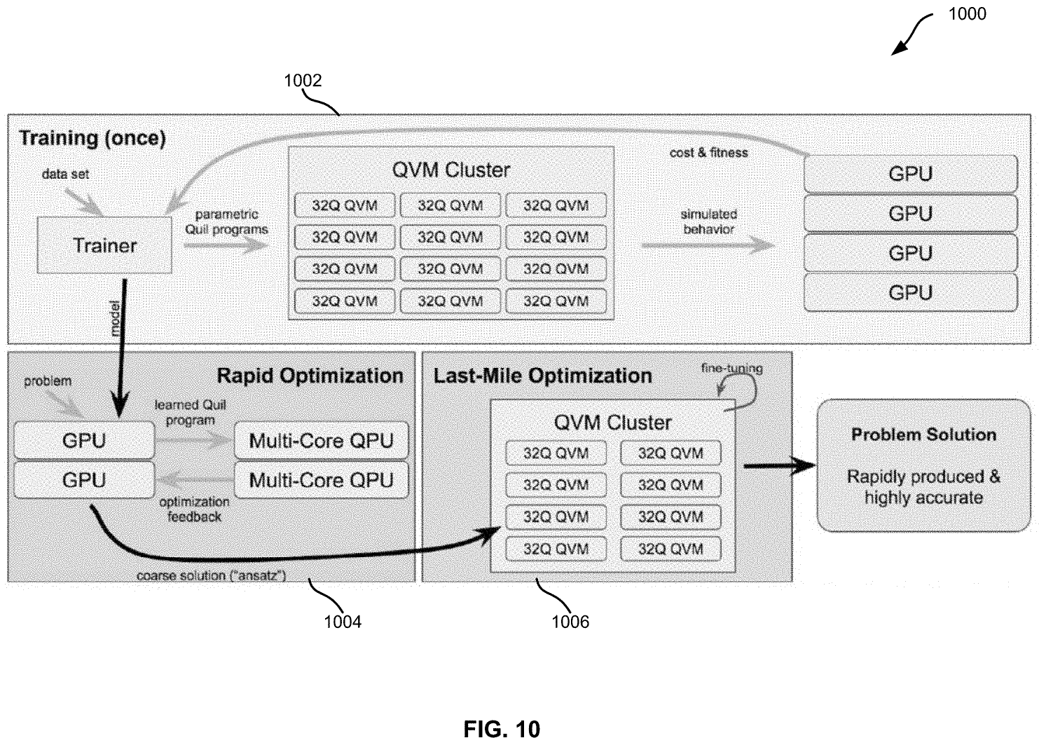

FIG. 10 is a flow diagram of an example process 1000 for synthesizing quantum logic circuits. The example process 1000 shown in FIG. 10 is an example implementation of the process 900 shown in FIG. 9.

At 1002, the agent uses a training process to train a neural network. The training process is executed based on a data set that includes one or more optimization problems (e.g., one or more MaxCut graphs). In the example shown, a trainer module generates a quantum program (e.g., a Quil program) based on a current version of the neural network, and a QVM cluster (which includes sixteen 32-qubit QVMs) is used as the quantum resource (e.g., as the quantum resource 314 in the processes 300, 500, 700) to simulate the behavior of the quantum program. The simulated behavior of the quantum program is then evaluated (e.g., using the “reward” criterion discussed above) and a set of GPUs are used to generate updated parameters for the neural network. The trainer may then update the neural network based on the updated parameters and generate an updated quantum program based on the updated neural network.

At 1004, the agent uses a rapid optimization process to improve a quantum program for a specific optimization problem. The rapid optimization process can sample one or more neural networks that were trained at 1002. In the example shown, a quantum program is provided as input; a group of GPUs and a group of multi-core QPUs are used to improve the quantum programs by sampling the one or more neural networks iteratively. In the example shown, the improved version of the quantum program produces an initial solution to the specific optimization problem.

At 1006, the agent uses a last-mile optimization process to fine-tune the initial solution. Because the initial solution is generated by QPUs that may be subject to noise, the initial solution may contain errors that can be eliminated by reducing the level of noise. In the example shown, a QVM Cluster (which includes eight 32-qubit QVMs) is used to execute the quantum program in a virtual (noise-free) environment. Therefore, a refined solution to the specific problem may provide an improvement over the initial solution generated at 1004. The last-mile optimization process may provide varying levels of improvement, depending, for example, on the level of noise affecting the quantum resources used at 1004.

In some implementations, a neural network policy or value function can be initialized for a training process (e.g., reinforcement learning implemented using classical, quantum or hybrid computing resources) using a set of exemplars and classically computable values. The initialization process may be deployed, for example, as a quick first step in a reinforcement learning process or another type of training process.

One of the basic challenges in the use of artificial intelligence systems to generate quantum programs is the cost of the training processes—the time cost as well as the cost of utilizing classical and quantum computing resources. In some examples, reinforcement learning agents work by estimating, through experience, either a policy function π or a state-action value function Q. Both work with the space [symbol] of observations (e.g., measurements of the quantum state as well as a numerical description of the problem instance) and actions [symbol] (e.g., corresponding to specific quantum gates).

Typical policy based algorithms (e.g., “Proximal Policy Optimization” or PPO) seek to find an optimal policy, which is a function π: [symbol] → [symbol] from the observation space to the action space. This policy can be optimized by the algorithm, and then used directly to construct new programs (e.g., a sequence of actions, determined by an intermediate sequence of observations).

Typical value function methods (such as “Deep Q Learning”) seek to find a function Q: [symbol] × [symbol] → [symbol] which represents, for a given observation and a candidate action, the value of this action. This function Q is estimated directly from experience. The construction of new programs however uses Q indirectly, by considering the associated policy

$${π}_{Q} ( o ) = arg {max}_{a} ( o , a ) .$$

In other words, the policy π_{Q} selects the action of the highest value.

In either approach (policy based methods and value function methods), the “truly optimal” choice of π or Q is unknown. One instead works with neural network realizations π(⋅; Θ) or Q(⋅, Ψ; Θ), where Θ is the set of neural network weights. These weights are typically optimized using machine learning or other related techniques. This involves an initial choice Θ₀ of weights (e.g. randomly selected weights), a problem-dependent cost or reward function, and a numerical optimization routine such as stochastic gradient descent. The routine involves updating the weights from experience, yielding (hopefully improving) a sequence of weights Θ₁, Θ₂, . . . .

Given the cost of training, starting with a random choice of weights Θ₀ can place a heavy burden on the model. Indeed, empirical observation suggests that, at least in some cases, a substantial amount of training time may be used to update the initial choice of Θ₀ to some values Θₖ corresponding to a reasonable algorithm.

One approach to alleviating the burden of training is to begin with an initialization process to initialize the policy or value function. The initialization process can be implemented as an initial optimization of the weights Θ based on the behavior of a classical algorithm. In other words, the initial weights Θ₀ can be selected so that the corresponding policy π or value function Q corresponds to a known classical algorithm. Then, training may proceed as usual, thus improving upon the classical algorithm (embodied by the initial weights Θ₀) with the usage of quantum resources.

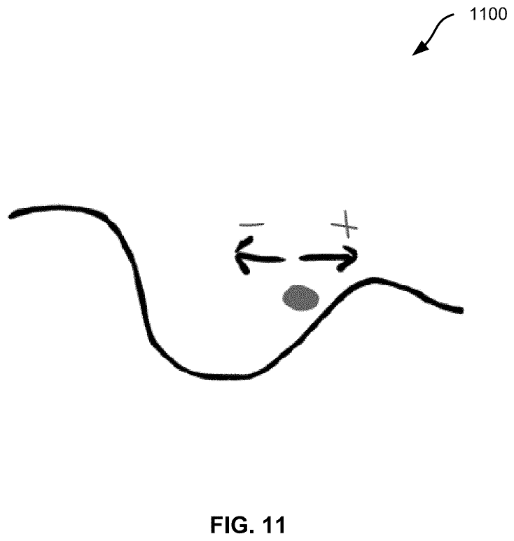

In some cases, the initialization process can compute the initial weights Θ₀ using a function. For example, FIG. 11 is a schematic diagram showing an example function 1100 that can be used in an initialization process. For instance, the example function 1100 may be used by a classical computer system to initialize a neural network or another type of policy before a training process that uses a quantum resource. For a training process that utilizes value function methods, the function 1100 used for initialization can be defined as

Q_{Greedy}(o,a):= [symbol] [r(o,a)],

which is the expected one-step reward associated with action a and observation o, relative to a reward function r. Note that this differs from the so-called “episode reward,” which involves a sequence of actions over time. The example function Q_{Greedy} is a measurement of the immediate value of an action. In the cartoon version of Q_{Greedy} shown in FIG. 11, the actions are “move left” and “move right”, with negative and positive values respectively. As shown in FIG. 11, seemingly greedy moves (“move right” or “move uphill”) can position the network weights in what amounts to a local optimum. The cartoon version in FIG. 11 shows only a single weight (along the x axis) for purposes of illustration, but typically there would be orders of magnitude more weights (e.g., hundreds, thousands, millions, etc.).

In some implementations, the example function 1100 or another type of function may be used to initialize the neural network 212 in FIG. 2 before the quantum resource 214 is used to train the neural network 212. Similarly, the example function 1100 or another type of function may be used to initialize the neural network 312 shown in FIGS. 3, 4, 5, 6, 7 before the quantum resource 314 is used to train the neural network 312.

The algorithm that computes actions by optimizing Q_{Greedy} is sometimes known as “local search” or “hill climbing search.” Supposing the expected rewards can be computed adequately, one may choose initial neural network weights Θ₀ by solving the following optimization problem

$${minimize}_{Θ} \qquad {\sum }_{i = 1}^{m} {\sum }_{j = 1}^{l} {\vert Q ( {o}_{i} , {a}_{j} ; Θ ) - {Q}_{Greedy} ( {o}_{i} , {a}_{j} ) \vert}^{2} ,$$

where {oᵢ}ᵢ₌₁^{m} is a set of training observations and {aⱼ}ⱼ₌₁^{l} is a set of training actions.

For a training process that utilizes policy function methods, which seek to find an optimal policy π(⋅; Θ), the function 1100 used for initialization can be defined as π_{Greedy}(oᵢ), which is the policy associated with the greedy value function Q_{Greedy}, and {oᵢ}ᵢ₌₁^{m} is a set of training observations. The initial weights Θ may then be initialized by solving the following optimization problem

$${minimize}_{Θ} \qquad {\sum }_{i = 1}^{m} {\vert π ( {o}_{i} ; Θ ) - {π}_{Greedy} ( {o}_{i} ) \vert}^{2} .$$

Accordingly, the initialization process may proceed with the following steps, in some implementations: (1.) Pick a set of quantum observations {oᵢ}ᵢ₌₁^{m} and candidate actions {aⱼ}ⱼ₌₁^{l}; (2.) Precompute the values of Q_{Greedy}(oᵢ, aⱼ), using either classical or quantum resources; and (3.) Choose Θ by solving the appropriate optimization problem (e.g., either of the two examples above), depending on whether the reinforcement learning algorithm is based on value function estimation or policy optimization. This step may be executed by classical resources, for example, using standard optimization procedures.

As a concrete example, consider the MaxCut problem using Q-learning. We may take observations o of the form o=(|b [symbol] , g) where |b [symbol] is a basis state represented by bitstring b, an g is a random graph. Then for quantum gates a, the result of applying a to |b [symbol] results in an easily-computed distribution over bitstrings, and hence the right hand side of the equation for Q_{Greedy}(o, a) above may be computed classically. The initial weights Θ are thus fit to a classical “local search” algorithm.

In some aspects of what is described above, artificial intelligence systems (e.g., reinforcement learning systems) are configured to program a quantum computer to solve certain problems which a priori have no relationship with quantum computing (e.g., combinational optimization problems, etc.). For instance, the artificial intelligence systems can be configured with application-specific reward functions (e.g., the MAXCUT weight) and application-specific data (e.g., edge weights of a weighted graph) as input to the policy. The quantum programs synthesized by the artificial intelligence system represent computed solutions to these computational problems. Moreover, to solve these problems in a practically efficient manner, constraints can be imposed on the policy network and measurement protocols. In the examples described above, such constraints are manifest in the “state space” of the reinforcement learning agents (to keep the size tractable) and the training protocol (to allow for pure-QPU training, as would be necessary in larger systems). For example, the learning agents described above do not rely on unmeasurable data or classical training, so that the learning agents can scale to larger systems (larger problem sizes, to be solved with quantum computers with larger numbers of qubits) without intractable scalability problems.

Some of the subject matter and operations described in this specification can be implemented in circuitry, or in computer software, firmware, or hardware, including the structures disclosed in this specification and their structural equivalents, or in combinations of one or more of them. Some of the subject matter described in this specification can be implemented as one or more computer programs, i.e., one or more modules of computer program instructions, encoded on a computer storage medium for execution by, or to control the operation of, data-processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

Some of the operations described in this specification can be implemented as operations performed by a data processing apparatus on data stored on one or more computer-readable storage devices or received from other sources.

The term “data-processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

In a general aspect, a quantum program is automatically synthesized. These and other aspects of the description above can be implemented according to the following examples or in another manner.

Example 1: A method comprising: obtaining quantum state information computed from quantum processor output data generated by a quantum resource executing an initial version of a quantum program; providing neural network input data to a neural network, the neural network input data comprising the quantum state information and a representation of a problem to be solved by the quantum program; obtaining neural network output data generated by the neural network processing the neural network input data; selecting a quantum logic gate based on the neural network output data; and generating an updated version of the quantum program that includes the selected quantum logic gate.

Example 2: The method of Example 1, wherein the neural network input data comprise a state and a reward based on the quantum processor output data.

Example 3. The method of Example 2, wherein the state comprises the quantum state information and the representation of the problem to be solved by the quantum program.

Example 4. The method of Example 3, wherein the state comprises: a binary array containing qubit measurements from the quantum resource executing multiple shots of the initial version of the quantum program; and an array containing weights of a graph representation of the problem.

Example 5: The method of Example 3, comprising encoding the problem.

Example 6: The method of Example 3, wherein the problem to be solved comprises a combinatorial optimization problem.

Example 7: The method of Example 3, wherein the problem to be solved comprises finding a ground state of a molecule.

Example 8: The method of Example 3, wherein the reward comprises a Hamiltonian expectation value based on the problem to be solved.

Example 9: The method of any preceding Example, wherein the neural network output data comprise a set of values associated with a set of quantum logic gates, and the value associated with each quantum logic gate represents a prediction of a degree to which the quantum logic gate improves the quantum program.

Example 10: The method of Example 9, wherein selecting the quantum logic gate comprises: identifying a maximum value in the set of values; and identifying the quantum logic gate associated with the maximum value.

Example 11: The method of Example 9, wherein the set of quantum logic gates comprises an action space comprising: a set of discrete-angle single-qubit rotation gates for each of a plurality of qubits; and a set of two-qubit entangling gates for each distinct pair of qubits in the plurality of qubits.

Example 12: The method of any preceding Example, wherein the initial version comprises a quantum logic circuit comprising a series of quantum logic gates, and generating the updated version comprises appending the selected quantum logic gate to the end of the series.

Example 13: The method of Example 12, wherein appending the selected quantum logic gate to the series improves the quantum program according to a reward defined by the problem to be solved by the quantum program.

Example 14: The method of any preceding Example, wherein the quantum logic gate comprises a parametric gate.

Example 15: The method of Example 14, comprising: obtaining additional quantum processor output data generated by the quantum resource executing the updated version of a quantum program; and selecting a value of a variable parameter of the parametric gate based on the additional quantum processor output data.

Example 16: The method of any preceding Example, comprising appending a change of basis operation to the updated version of the quantum program.

Example 17: The method of any preceding Example, comprising modifying the neural network based on reward data computed from the quantum processor output data.

Example 18: The method of Example 17, wherein the reward data comprises a cost function based on a Hamiltonian.

Example 19: The method of Example 17, wherein the neural network is modified according to a deep reinforcement learning process.

Example 20: The method of any preceding Example, comprising executing an iterative process, where each iteration of the iterative process includes: compiling an initial version of the quantum program for the iteration; generating quantum processor output data for the iteration by executing the quantum program compiled for the iteration; computing quantum state information for the iteration based on the quantum processor output data for the iteration; operating the neural network to produce neural network output data for the iteration based on the quantum state information for the iteration; selecting a quantum logic gate for the iteration based on the neural network output data for the iteration; and generating an updated version of the quantum program that includes the selected quantum logic gate for the iteration.

Example 21: The method of any preceding Example, wherein the neural network output data are generated by the neural network being executed on a classical processor.

Example 22: The method of any preceding Example, comprising: operating the quantum resource to execute the initial version of the quantum program; and operating the quantum resource to execute the updated version of the quantum program.

Example 23: The method of any preceding Example, wherein the quantum resource comprises a quantum processor unit.

Example 24: The method of any preceding Example, wherein the quantum resource comprises multiple quantum processor units configured to operate in parallel.

Example 25: The method of any preceding Example, wherein the quantum resource comprises a quantum virtual machine.

Example 26: The method of any preceding Example, wherein the quantum resource comprises multiple quantum virtual machines configured to operate in parallel.

Example 27: The method of Example 1, wherein the quantum state information comprises a bitstring representing a measurement of qubit states generated by the quantum resource executing the initial version of the quantum program.

Example 28: The method of Example 1, wherein the quantum processor output data are generated by the quantum resource executing multiple shots of the initial version of the quantum program, the quantum state information comprises a plurality of bitstrings, and each bitstring represents a measurement of qubit states generated by a respective one of the multiple shots.

Example 29: A computer system configured to perform the method of any preceding Example.

Example 34: A method comprising: computing a reward from quantum processor output data generated by a quantum resource executing an initial version of a quantum program, wherein the reward is computed according to a problem to be solved by a policy; modifying the policy based on the reward; obtaining policy output data generated by the modified policy processing the reward and a representation of the problem to be solved; selecting a quantum logic gate based on the policy output data; and generating an updated version of the quantum program that includes the selected quantum logic gate.

Example 35: The method of Example 34, further comprising initializing the policy based on a classical solution to the problem.

Example 36: The method of Example 34, comprising modifying the policy according to a Proximal Policy Optimization (PPO) algorithm.

Example 37: The method of Example 34, wherein the problem to be solved comprises a combinatorial optimization problem.

Example 38: The method of Example 34, wherein the problem to be solved comprises a MAXCUT problem instance, a MAXQP problem instance or a QUBO problem instance.

Example 39: The method of Example 34, wherein the policy comprises a neural network comprising a plurality of layers and a plurality of trainable weights, and modifying the policy comprises modifying the trainable weights of the neural network.

Example 40: The method of Example 39, comprising: initializing the trainable weights; and generating the initial version of a quantum program based on the neural network comprising the initialized trainable weights.

Example 41: The method of Example 40, comprising initializing the trainable weights to random values.

Example 42: The method of Example 40, comprising initializing the trainable weights based on a one-step reward associated with a set of actions and observations.

Example 43: A computer system configured to perform the method of any one of Examples 34 through 42.

Example 44: The method of Example 20, wherein a Hamiltonian of the representation of the problem admits a diagonal form with respect to a computational basis of the representation of the problem, and the method comprises, after generating an updated version of the quantum program: determining angles of rotation gates present in the updated version of the quantum program; and terminating the iterative process if any angles of X rotation gates deviate from π by more than π/2 radians.

While this specification contains many details, these should not be understood as limitations on the scope of what may be claimed, but rather as descriptions of features specific to particular examples. Certain features that are described in this specification or shown in the drawings in the context of separate implementations can also be combined. Conversely, various features that are described or shown in the context of a single implementation can also be implemented in multiple embodiments separately or in any suitable subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

A number of embodiments have been described. Nevertheless, it will be understood that various modifications can be made. Accordingly, other embodiments are within the scope of the following claims.

1. A method comprising:
obtaining quantum state information computed from quantum processor output data generated by a quantum resource executing an initial version of a quantum program;
providing neural network input data to a neural network, the neural network input data comprising the quantum state information and a representation of a problem to be solved by the quantum program;
obtaining neural network output data generated by the neural network processing the neural network input data;
selecting a quantum logic gate based on the neural network output data; and
generating an updated version of the quantum program that includes the selected quantum logic gate.

2. The method of claim 1, wherein the neural network input data comprise a state and a reward based on the quantum processor output data.

3. The method of claim 2, wherein the state comprises the quantum state information and the representation of the problem to be solved by the quantum program.

4. The method of claim 3, wherein the state comprises:
a binary array containing qubit measurements from the quantum resource executing multiple shots of the initial version of the quantum program; and
an array containing weights of a graph representation of the problem.

5. The method of claim 3, comprising encoding the problem.

6. The method of claim 3, wherein the problem to be solved comprises a combinatorial optimization problem or finding a ground state of a molecule.

7. (canceled)

8. The method of claim 3, wherein the reward comprises a Hamiltonian expectation value based on the problem to be solved.

9. The method of claim 1, wherein the neural network output data comprise a set of values associated with a set of quantum logic gates, and the value associated with each quantum logic gate represents a prediction of a degree to which the quantum logic gate improves the quantum program.

10. The method of claim 9, wherein selecting the quantum logic gate comprises:
identifying a maximum value in the set of values; and
identifying the quantum logic gate associated with the maximum value.

11. The method of claim 9, wherein the set of quantum logic gates comprises an action space comprising:
a set of discrete-angle single-qubit rotation gates for each of a plurality of qubits; and
a set of two-qubit entangling gates for each distinct pair of qubits in the plurality of qubits.

12. The method of claim 1, wherein the initial version comprises a quantum logic circuit comprising a series of quantum logic gates, and generating the updated version comprises appending the selected quantum logic gate to the end of the series.

13. The method of claim 12, wherein appending the selected quantum logic gate to the series improves the quantum program according to a reward defined by the problem to be solved by the quantum program.

14. (canceled)

15. The method of claim 1, comprising:
obtaining additional quantum processor output data generated by the quantum resource executing the updated version of a quantum program; and
selecting a value of a variable parameter of the quantum logic gate based on the additional quantum processor output data;
wherein the quantum logic gate comprises a parametric gate.

16. (canceled)

17. The method of claim 1, comprising modifying the neural network based on reward data computed from the quantum processor output data.

18. The method of claim 17, wherein the reward data comprises a cost function based on a Hamiltonian.

19. The method of claim 17, wherein the neural network is modified according to a deep reinforcement learning process.

20. The method of claim 1, comprising executing an iterative process, where each iteration of the iterative process includes:
compiling an initial version of the quantum program for the iteration;
generating quantum processor output data for the iteration by executing the quantum program compiled for the iteration;
computing quantum state information for the iteration based on the quantum processor output data for the iteration;
operating the neural network to produce neural network output data for the iteration based on the quantum state information for the iteration;
selecting a quantum logic gate for the iteration based on the neural network output data for the iteration; and
generating an updated version of the quantum program that includes the selected quantum logic gate for the iteration.

21-22. (canceled)

23. The method of claim 1, wherein the quantum resource comprises a quantum processor unit, multiple quantum processor units configured to operate in parallel, a quantum virtual machine, or multiple quantum virtual machines configured to operate in parallel.

24-27. (canceled)

28. The method of claim 1, wherein the quantum processor output data are generated by the quantum resource executing multiple shots of the initial version of the quantum program, the quantum state information comprises a plurality of bitstrings, and each bitstring represents a measurement of qubit states generated by a respective one of the multiple shots.

29. (canceled)

30. A method comprising:
computing a reward from quantum processor output data generated by a quantum resource executing an initial version of a quantum program, wherein the reward is computed according to a problem to be solved by a policy;
modifying the policy based on the reward;
obtaining policy output data generated by the modified policy processing the reward and a representation of the problem to be solved;
selecting a quantum logic gate based on the policy output data; and
generating an updated version of the quantum program that includes the selected quantum logic gate.

31. The method of claim 30, further comprising initializing the policy based on a classical solution to the problem.

32. (canceled)

33. The method of claim 30, wherein the problem to be solved comprises a combinatorial optimization problem, a MAXCUT problem instance, a MAXQP problem instance or a QUBO problem instance.

34. (canceled)

35. The method of claim 30, wherein the policy comprises a neural network comprising a plurality of layers and a plurality of trainable weights, and modifying the policy comprises modifying the trainable weights of the neural network.

36. The method of claim 35, comprising:
initializing the trainable weights; and
generating the initial version of a quantum program based on the neural network comprising the initialized trainable weights.

37. The method of claim 36, comprising initializing the trainable weights to random values or initializing the trainable weights based on a one-step reward associated with a set of actions and observations.

38-39. (canceled)

40. The method of claim 20, wherein a Hamiltonian of the representation of the problem admits a diagonal form with respect to a computational basis of the representation of the problem, and the method comprises, after generating an updated version of the quantum program:
determining angles of rotation gates present in the updated version of the quantum program; and
terminating the iterative process if any angles of X rotation gates deviate from π by more than π/2 radians.
